(19) United States
(12) Patent Application Publication
(10) Pub. No.: US 2026/0230019 A1
(43) Pub. Date: Aug. 6, 2026

(54) NOISE REDUCTION CIRCUITRY

(71) Applicant: Joseph Luis Sousa, Billerica, MA (US)

(72) Inventor: Joseph Luis Sousa, Billerica, MA (US)

(21) Appl. No.: 19/399,326

(22) Filed: Nov. 24, 2025

Related U.S. Application Data
(63) Continuation-in-part of application No. 19/210,936, filed on May 16, 2025, now abandoned.
Application No. 19/210,936 is a continuation-in-part of application No. 17/932,870, filed on Sep. 16, 2022, now Pat. No. 12,328,555.
(60) Provisional application No. 63/261,399, filed on Sep. 20, 2021.

(51) Int. Cl. H02P 21/22; H02P 21/14

(52) U.S. Cl. CPC H02P 21/22; H02P 21/141

(57) ABSTRACT

Noise reduction is provided for signals comprising a common data element. From first and second signals, virtual flux patterns are generated representing a surface integral of a virtual vector field. A plurality of virtual flux magnitude patterns are generated based on the plurality of virtual flux patterns, each of the plurality of virtual flux magnitude patterns representing an absolute value of a respective one of the plurality of virtual flux patterns. A virtual flux beam is then generated as a function of the plurality of virtual flux magnitude patterns, the virtual flux beam being a noise-reduced signal corresponding to the common data element of the first and second signals.

### RELATED APPLICATION

This application is a Continuation-in-Part of U.S. application Ser. No. 19/210,936, filed May 16, 2025, which is a Continuation-in-Part of U.S. application Ser. No. 17/932,870, filed Sep. 16, 2022, which claims the benefit of U.S. Provisional Application No. 63/261,399, filed on Sep. 20, 2021. The entire teachings of the above applications are incorporated herein by reference.

### BACKGROUND

Conventional beamforming techniques depend on time delays between phased arrays of sensors to form the beam. Common sensors include phased antenna arrays for Radio Frequency beams, phased microphone arrays for sound beams and phased sensor arrays for ultrasound. The fundamental physics of these beams generates undesirable side lobes in the rejection zone and the reception zone has a necessarily curved sensitivity profile. The phased technique also necessarily distorts the phase of the on-beam signals. Reduction of the side lobes in the rejection zone requires a large number of sensors for still relatively poor results. The phasing technique also makes the beam shape strongly frequency dependent, usually degrading with higher frequencies. This is of particular importance in sound applications that cover up to three decades of bandwidth. In the case of relatively low RF frequencies of a few megahertz or less, the required antennas can become impractically large.

### SUMMARY

Example embodiments include a method of noise reduction. From first and second signals, virtual flux patterns may be generated representing a surface integral of a virtual vector field, the first and second signals being synchronous and comprising a common data element and distinct noise elements. A plurality of virtual flux magnitude patterns may be generated based on the plurality of virtual flux patterns, each of the plurality of virtual flux magnitude patterns representing an absolute value of a respective one of the plurality of virtual flux patterns. A virtual flux beam may then be generated as a function of the plurality of virtual flux magnitude patterns, the virtual flux beam being a noise-reduced signal corresponding to the common data element of the first and second signals.

The first and second signals may correspond to one of a radio signal, an audio signal, and an image. One of the first and second signals may be delayed relative to the other prior to generating the plurality of virtual flux magnitude patterns. The generation of the plurality of virtual flux magnitude patterns may be based on a delayed version of one of the first and second signals. The virtual flux beam may be a result of a mathematical operation comprising exclusively at least one of an addition and a subtraction of the plurality of virtual flux magnitude patterns.

Generating the plurality of virtual flux magnitude patterns may include processing each of the plurality of virtual flux signals via a Fourier transform. Generating the virtual flux beam may include processing a signal representing the plurality of flux magnitude patterns via an inverse Fourier transform.

Further embodiments include a circuit for signal noise reduction. A Fourier transform (FT) stage may be configured to perform FT on a first signal and a second signal, the first and second signals comprising a common data element and distinct noise elements, the FT stage outputting first and second TF signals. A delay block may be configured to output a delayed signal corresponding to the first TF signal. A first summation stage may be configured to sum the delayed signal and the second TF signal via a first linear matrix. A first difference stage may be configured to output a difference between the delayed signal and the second TF signal via a second linear matrix. A frequency filter may be configured to generate first and second equalized signals corresponding to outputs of the first summation stage and the first difference stage, respectively. A scaling stage may be configured to generate distinct first and second scaled signals corresponding to the first equalized signal. A second summation stage may be configured to generate sums of 1) the first scaled signal and the second equalized signal, and 2) the second scaled signal and the second equalized signal. A second difference stage configured to output a difference between the sums generated by the second summation stage. A third summation stage may be configured to output a reduced noise signal based on a summation of the output of the second difference stage and a signal corresponding to the first equalized signal.

The FT stage may be a short-time Fourier transform (STFT) stage configured to perform STFT on the first signal and a second signal, and wherein the first and second FT signals are SFTF signals. The STFT stage may be configured to perform the STFT via a rectangular window. The FT stage may implement a straight sequential Fourier transform that is absent an overlap-add function. The delay block may output the delayed signal with a 90-degree delay.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-C are plots depicting a single flux signal.

FIGS. 2A-C are plots depicting addition of two flux signals.

FIGS. 3A-C are plots depicting a flux magnitude.

FIGS. 4A-C are plots depicting a flux magnitude addition in one embodiment.

FIGS. 5A-C are plots depicting flux beam shaping in one embodiment.

FIG. 6 is a diagram of an apparatus generating a flux beam in one embodiment.

FIG. 7 is a diagram of a circuit providing beam shaping in one embodiment.

FIG. 8 is a flow diagram of a process of generating a flux beam in one embodiment.

FIGS. 9A-C are plots depicting unidirectional beam forming in one embodiment.

FIG. 10 is a diagram of a circuit providing headlight beamforming in one embodiment.

FIGS. 11A-C are plots depicting hemisphere beam forming in one embodiment.

FIGS. 12A-C are plots depicting wide notch beam forming in one embodiment.

FIGS. 13A-C are plots depicting annular beam forming in one embodiment.

FIGS. 14A-C are plots depicting headlight beam forming in one embodiment.

FIGS. 15A-C are plots depicting fan beam forming in one embodiment.

FIGS. 16A-C are plots depicting spear beam forming in one embodiment.

FIGS. 17A-E are plots depicting two-dart beam forming in one embodiment.

FIGS. 18A-E are plots depicting two-tile beam forming in one embodiment.

FIGS. 19A-C are plots depicting half shell beam forming in one embodiment.

FIGS. 20A-D are plots depicting combined beam forming in one embodiment.

FIG. 21 is a diagram of a circuit providing combined beam forming in one embodiment.

FIG. 22 is a diagram illustrating processing of sound waves via a microphone array in one embodiment.

FIGS. 23A-C are plots depicting hypercarioid signals in one embodiment.

FIG. 24 is a set of plots depicting a headlight beam formed with delay type hypercardioid microphones in one embodiment.

FIG. 25 is a set of plots depicting a headlight beam formed with sum type hypercardioid microphones in one embodiment.

FIG. 26 is a set of plots depicting a headlight beam formed with sum type hypercardioid microphones in a further embodiment.

FIGS. 27-29 are plots depicting the effects of microphone mismatches in one embodiment.

FIGS. 30-31 are plots depicting headlight beams generated in an example embodiment.

FIG. 32 is a set of plots depicting a 3-microphone array in an example embodiment.

FIG. 33 illustrates a tetrahedron microphone array in an example embodiment.

FIGS. 34-38 are plots depicting rotated headlight beams in one embodiment.

FIG. 39 is a set of plots illustrating a capture effect associated with a headlight beam in one embodiment.

FIG. 40 is a plot depicting a multiplication of clamshell and headlight beams in one embodiment.

FIGS. 41-42 are plots depicting an emitted burst and echo in one embodiment.

FIG. 43 is a plot depicting the position of multiple signal sources relative to a sensor array in one embodiment.

FIG. 44 is a plot depicting a set of signals detected by the sensor array shown in FIG. 43.

FIG. 45 is a series of plots showing the signal resulting from different stages of processing in one embodiment.

FIG. 46 are polar and cartesian plots showing a headlight beam an applied delay.

FIG. 47 is a plot of an audio clip illustrating noise reduction in one example.

FIG. 48 is a frequency spectrum plot corresponding to the plot of FIG. 47.

FIG. 49 is a flow diagram depicting a headlight beamforming process in one embodiment.

FIGS. 50A-C are flow diagram depicting a headlight beamforming process in one embodiment.

FIGS. 51A-D are a series of images illustrating the result of a noise reduction process in one embodiment.

### DETAILED DESCRIPTION

A description of example embodiments follows. The teachings of all patents, published applications and references cited herein are incorporated by reference in their entirety.

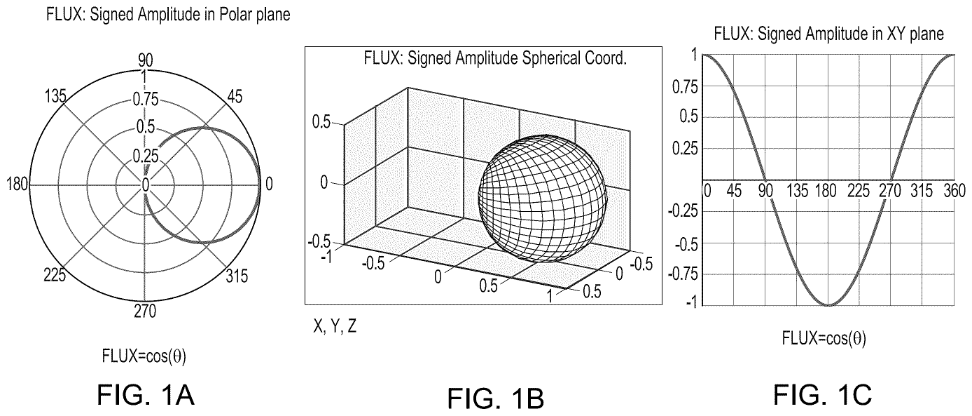

FIGS. 1A-C are plots depicting a single flux signal. Flux is considered here for its properties that are independent of time or phase. A magnetic flux, a light flux or a sound velocity flux are relevant examples. The amount of unidirectional parallel flux through a finite planar surface depends on the intensity and angle of the flux. The pattern for signed amplitude representation of this flux on a horizontal plane slice in polar coordinates is a pair of coincident circles, in spherical coordinates it is a pair of coincident spheres and a horizontal plane slice in Cartesian coordinates has a sine shape. The description below assumes a parallel unidirectional flux through a closed surface.

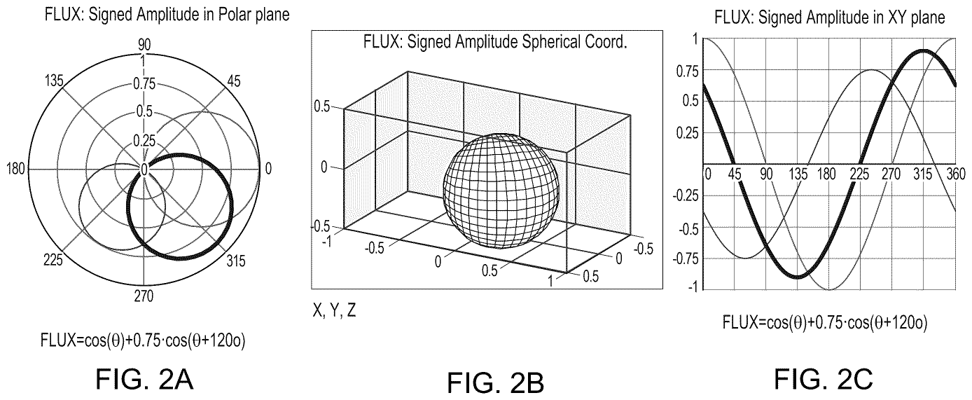

FIGS. 2A-C are plots depicting addition of two flux signals. If two different fluxes of the same physical type, are added together, the resulting beam shape will remain identical to that of a single flux, but with a new magnitude and angular orientation. This means that beam forming of a flux cannot be achieved by linearly adding different fluxes. In the example shown, the black pattern is the sum of the red and blue patterns. The spherical representation in the FIG. 2B only shows the resulting sum of the two fluxes. Note that it appears rotated and slightly diminished compared to the representation of FIG. 1B.

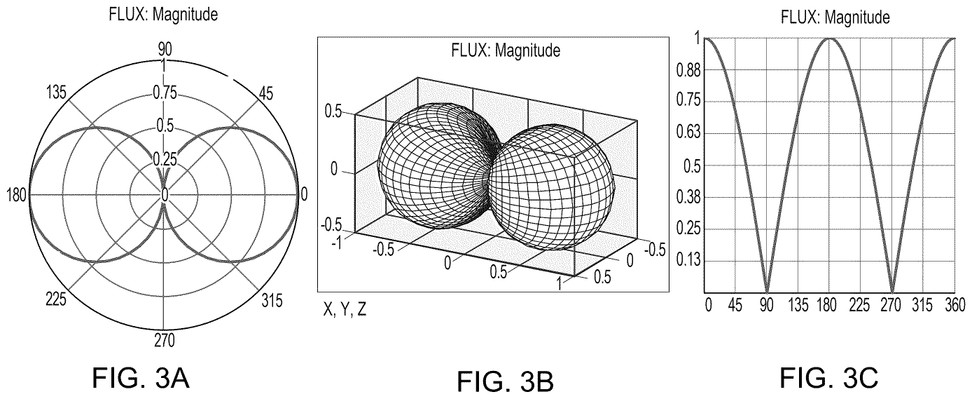

FIGS. 3A-C are plots depicting a flux magnitude. The absolute value (magnitude) of the flux has a related pattern to the signed magnitude flux, but the magnitude of the sine functions that describe the shape shows patterns with only positive values. The 2D slice now has two sharp notches. The 3D pattern is no longer a pair of coincident spheres, but a pattern of tangential spheres. The notches of the pattern are at the tangential point.

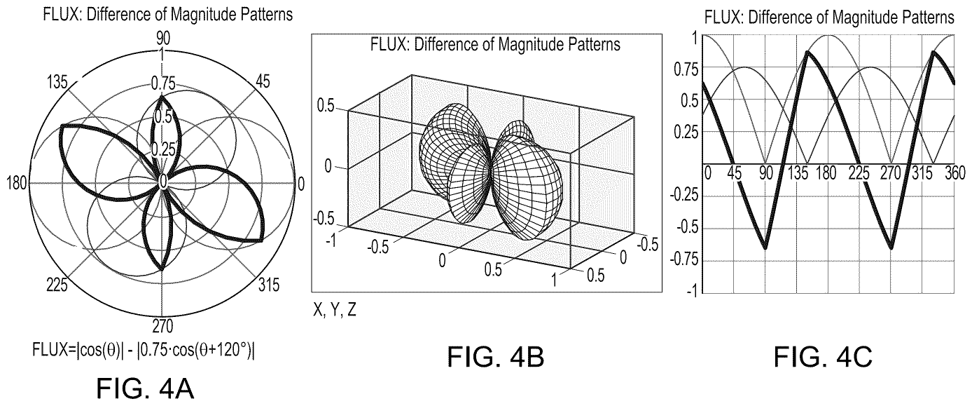

FIGS. 4A-C are plots depicting a flux magnitude addition in one embodiment. If the magnitude patterns are combined with scaled addition or subtraction, new shapes emerge, thus opening the potential for flux beam forming. This example repeats the elemental patterns of the linear signed magnitude sum, but using only their magnitude to illustrate that sharper beam shapes are possible. In this example, the black pattern is the difference between the red magnitude and blue magnitude patterns. The rectified sine shape of a figure-8 pattern is rich in spatial harmonics, so that new shapes can be created by adding or subtracting rectified sine shapes of different spatial amplitudes and phases. Scaled sums of pure sine shapes of flux can't create new shapes because a pure spatial sine has no spatial harmonics.

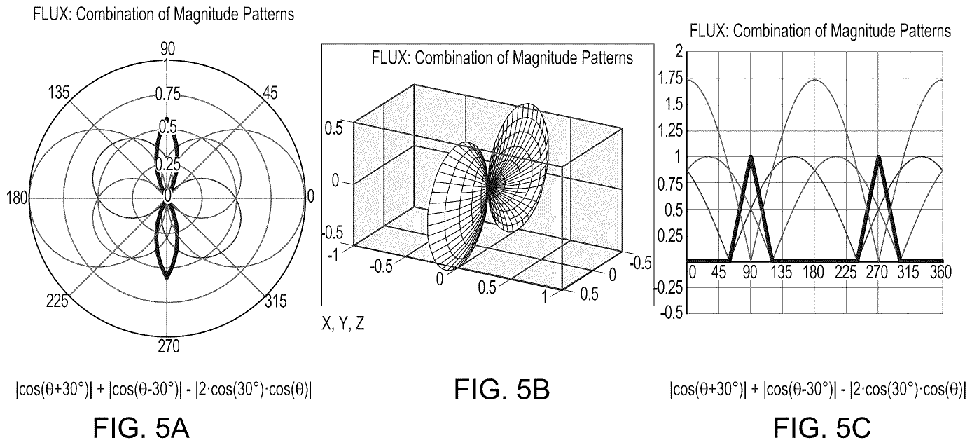

FIGS. 5A-C are plots depicting flux beam shaping in one embodiment. This first example of useful beam forming adds two equal magnitude figure-8 flux patterns rotated +40° in red and −40° in blue and subtracts a third pattern in magenta that is not rotated and its amplitude is equal to the sum of the other two patterns at 0° or 180°, which is 2*cos(40°). See this clearly in the polar and XY plots. This flux pattern is extremely sharp with two identical lobes. The shape is that of glued pairs of clamshells with two circular peripheries. Each lobe is shaped with spherical sections. Note that there are no other side lobes at all. The directions outside the two lobes have absolute zero amplitude. The third plot in XY coordinates shows the zero response between the main lobes very clearly. The vertical cross-section is a figure-8.

In practice, this flux sensing pattern may be constructed from three independent flux sensors (i.e. magnetic loops, photo cells or velocity microphones). But one can also start with one orthogonal set of sensors and then create any newly oriented figure-8 patterns with simple weighed linear sums or subtractions of the signed signals from the orthogonal set. If only 2D rotation is desired, one orthogonal set of three sensors is enough. For 3D rotation, an orthogonal set of four sensors may be implemented.

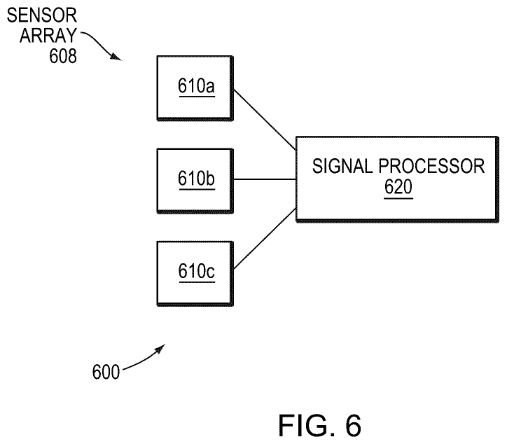

FIG. 6 is a diagram of an apparatus 600 configured to generate a flux beam in one embodiment. The apparatus 600 may include a sensor array 608, comprising a plurality of sensors (e.g., sensors 610a-c, optionally including additional sensors not shown), and a signal processor 620. The sensor array 608 may be configured to detect a plurality of flux signals, such as magnetic fluxes, light fluxes, sound velocity fluxes, radio frequency magnetic flux signals, ultrasound velocity flux signals, infrasound or seismic velocity flux signals, fixed flux signals, and variable flux signals. If detecting sound velocity fluxes, for example, the sensors 610a-c of the array 608 may include at least two microphones, the plurality of flux signals being sound velocity fluxes. Sound velocity fluxes may be based on a spatial difference of a sound pressure measured by the at least two microphones. The microphones may be omnidirectional microphones, figure-8 microphones, cardioid microphones, hyper-cardioid microphones, and/or super-cardioid microphones, for example. Alternatively, if detecting magnetic fluxes, the sensors 610a-c of the array 608 may include one or more electric field sensors and/or magnetic loop antennas, and the magnetic fluxes may be based on a spatial difference of two varying electric field signals detected by the sensor array. The sensors 610a-c of the array 608 may also include one or more hall effect sensors and/or flux gate sensors.

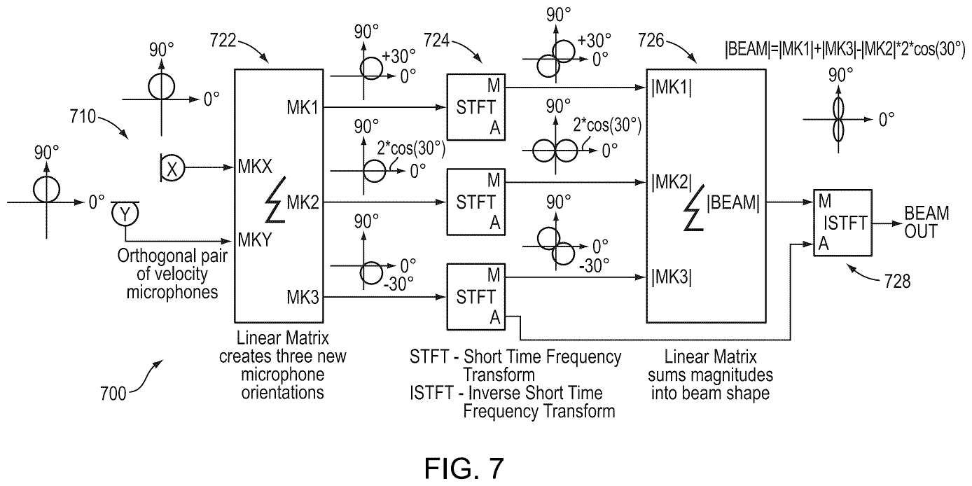

The signal processor 620 may be configured to 1) generate a plurality of flux patterns based on the plurality of flux signals, each of the plurality of flux patterns representing a respective one of the plurality of flux signals; 2) generate a plurality of flux magnitude patterns based on the plurality of flux patterns, each of the plurality of flux magnitude patterns representing an absolute value of a respective one of the plurality of flux patterns; and 3) generate a flux beam as a function of the plurality of flux magnitude patterns. To perform the above operations, the signal processor 620 may incorporate one or more circuits as described herein, such as the circuits described below with reference to FIGS. 7, 10, and 21.

The flux beam generated by the signal processor 620 may be a function of at least one flux phase pattern, which may represent a phase of a respective one of the plurality of flux patterns. The signal processor 620 may be further configured to 1) generate a plurality of flux phase patterns based on the plurality of flux signals, each of the plurality of flux phase patterns representing a phase of a respective one of the plurality of flux signals; and 2) generate the flux beam as a function of the plurality of flux phase pattern.

For the plurality of sensors 610a-c, a first sensor 610a may be assigned as a pivot as described further below, and the signal processor 620 may generate a virtual sensor via linear interpolation between a remainder of the plurality of sensors. The signal processor may generate a plurality of flux phase patterns, including the at least one flux phase pattern, based on the plurality of flux signals, each representing a phase of a respective one of the plurality of flux signals. The flux beam may be generated as a function of at least one flux phase pattern, the at least one flux phase pattern representing a phase of a respective one of the plurality of flux patterns.

The sensor array 608 may include three sensors 610a-c positioned at points of a triangle, and the signal processor 620 may assign a first sensor 610a as a pivot, and then generate a virtual plane-rotated sensor via linear interpolation between the second sensor 610b and the third sensor 610c. Alternatively, the sensor array 608 may include four sensors positioned at points of a tetrahedron, and the signal processor may assign a first sensor 610a as a pivot, and then generate a virtual sensor with two plane rotations via linear interpolation between the remaining sensors.

FIG. 7 is a diagram of a circuit 700 providing beam shaping in one embodiment, which may be implemented in the signal processor 620 described above with reference to FIG. 6. This illustrative example represents the steady state velocity flux patterns of 3 collocated ribbon microphones 710. The circuit 700 first synthesizes three virtual microphones from scaled sums of the input orthogonal pair of velocity flux microphones via a first linear matrix 722. The first linear matrix 722 can be used to obtain any rotation in the virtual microphones and thus any rotation in the final beam. The flux magnitude beam forming may be done in the frequency domain, wherein a set of short time frequency transform (STFT) blocks receive the output from the first linear matrix 722 and provide respective flux magnitude patterns to a second linear matrix 726. The amplitude term of each frequency bin may be used in the flux beam forming calculations and the phase may be bypassed from one or a combination of the input sensors to the output. From the point of view of flux magnitude beam forming, there may be negligible phase difference between the collocated ribbon microphones. Bins that only capture audio from the rejection zone of the beam will have zero amplitude but with the original phase. In the special case of a fixed DC flux field, which would be bin 0 in a frequency record, the sign of the input field is passed to the output to multiply with the output magnitude to reestablish the polarity of the flux. The second linear matrix 726 sums the flux magnitude patterns into beam shapes, which are received by an inverse short time frequency transform (ISTFT) block 728 to generate a resulting flux beam.

While manipulating the amplitude of a frequency bin independently of its phase is a nonlinear operation, no new harmonics are created. If content from two directions is in one frequency bin, and if the dominant source is off-beam, the beam is silenced, if the dominant direction is on-beam, then the on-beam magnitude is attenuated by the off-beam signals. The block diagram shows the simplest implementation for the phase A taken from the virtual microphone MK3. A lower noise solution with less phase interference from off-beam signals would use one more STFT blocks 724 to transform signal from the 90° direction to produce the phase for the output.

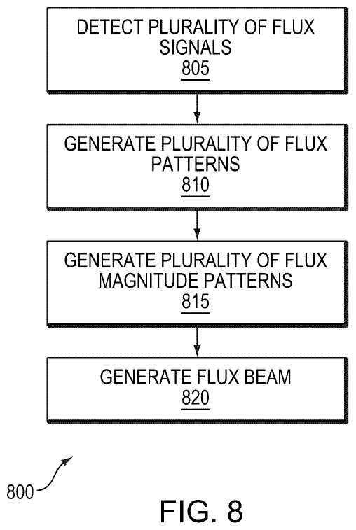

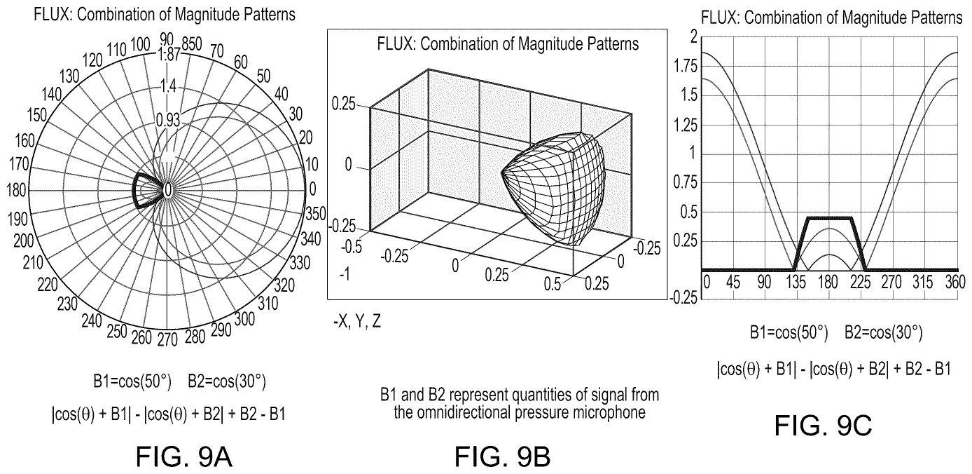

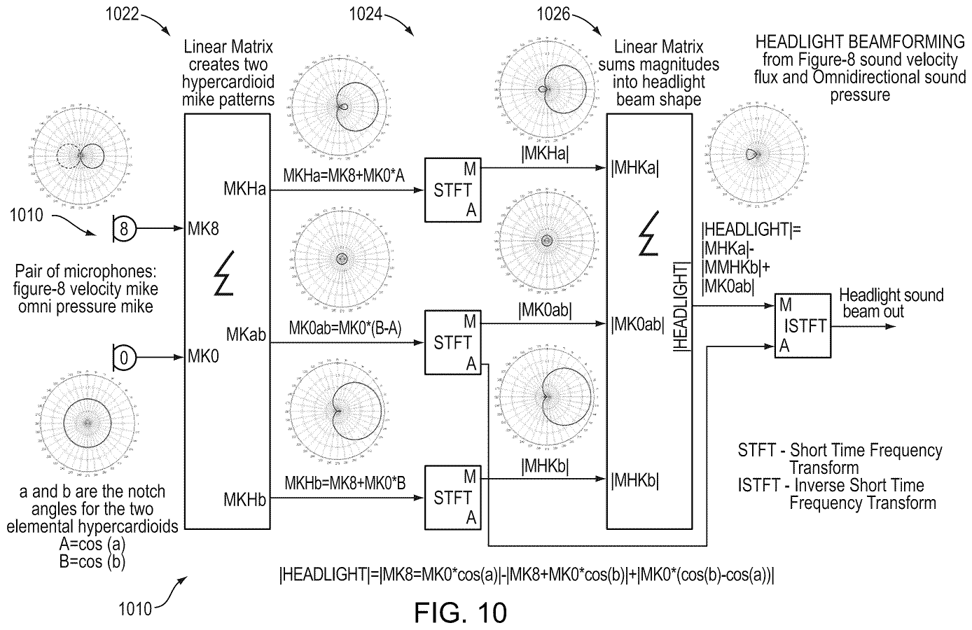

FIG. 8 is a flow diagram of a process 800 of generating a flux beam in one embodiment. The process 800 may be implemented by the apparatus 600 described above, optionally with one or more of the circuits also described herein. With reference to FIG. 6, a plurality of flux signals may be detected via a sensor array 608 comprising a plurality of sensors 610a-c (805). The plurality of flux signals may be a subset of flux signals detected by the sensor array 608, and the subset of flux signals may have a common frequency (e.g., zero). The subset may be a first subset, and the process 800 may further comprise generating a subsequent flux pattern as a function of a second subset of flux signals having a common frequency that is distinct from the frequency of the first subset.

Via the signal processor 620, for example, a plurality of flux patterns may then be generated based on the plurality of flux signals, each of the plurality of flux patterns representing a respective one of the plurality of flux signals (810). The flux pattern may be a result of one or more processing operations as described herein. For example, the flux pattern may be a result of 1) a linear sum and a linear difference of magnitudes of the subset of flux signals, 2) a sum, a difference, and/or a multiplication of magnitudes of the subset of flux signals in a frequency domain, and/or 3) a sum, a difference, and/or a multiplication of magnitudes of the subset of flux signals in an inverse of a frequency domain, the inverse of the frequency domain being a time domain and/or a space domain.

A plurality of flux magnitude patterns may be generated based on the plurality of flux patterns, each of the plurality of flux magnitude patterns representing an absolute value of a respective one of the plurality of flux patterns (815). For example, generating the flux magnitude patterns may include processing each of the plurality of flux signals via a Fourier transform. A flux beam may then be generated as a function of the plurality of flux magnitude patterns (820). For example, the flux pattern may be a result of at least one of an addition and a subtraction of the plurality of flux magnitude patterns and may include processing a signal representing the plurality of flux magnitude patterns via an inverse Fourier transform.

The flux beam may be a first flux beam, and the process 800 may further comprise combining a magnitude of the first flux beam with a magnitude of a second flux beam via a multiplication operation to generate a combined flux beam. The combined flux beam may be a function of a square root of the multiplication of the first flux beam and the second flux beam. The first flux pattern may be a unidirectional beam and the second flux pattern may be a bidirectional beam. Alternatively, the first flux pattern may be a bidirectional beam and the second flux pattern may be a bidirectional beam. Further still, the first flux pattern may be a unidirectional beam and the second flux pattern may be a unidirectional beam. The process 800 may further comprise 1) detecting an external signal propagated outside of the flux beam, 2) determining a frequency of the external signal, and 3) via flux beam formation, reducing a magnitude of signals detected within the flux beam that match the frequency.

FIGS. 9A-C are plots depicting unidirectional beam forming in one embodiment. Flux magnitude beam forming is fundamentally limited to bidirectional beams. This constraint can be broken by bringing in an omnidirectional component of the field being sensed. In the 1930's the addition of the sound pressure of an omnidirectional microphone to the velocity flux signal of a figure-8 ribbon microphone created the cardioid family of microphones. Then, like now in this presentation, the beam forming was not based on the time dependent properties of the sound field. The microphones were collocated as closely as possible. However, the cardioid family of patterns has very limited set of shapes, always with two opposing complementary sized lobes, where one lobe can be zero.

This example of flux magnitude beam forming subtracts the magnitude of two elemental hypercardioid patterns to create a unidirectional beam that is headlight shaped. The elemental hypercardioids have their notches at +/−30° and +/−50° with respect to 180°. The 3D figure in the second plot was reflected in the X-axis to see the spherical omnidirectional front of the beam with its fixed on-beam sensitivity. The front of the 3D beam shape is a section of sphere with its center at the origin. The front of the beam is a short flat line in the XY plot.

FIG. 10 is a diagram of a circuit 1000 providing headlight beamforming in one embodiment. Although the example circuit employs microphones to detect sound flux signals, alternative embodiments may employ other sensors as described herein to detect other flux signals. The circuit 1000 may be configured comparably to the circuit 700 described above. In particular, a first linear matrix 1022 may receive a signal input from a pair of microphones, such as a figure-8 velocity microphone and an omni pressure microphone 1010, and may create two hypercardioid microphone patterns. A set of STFT blocks 1024 may generate respective flux magnitude patterns, which are implemented by a second linear matrix 1026 to sum the magnitudes into a headlight beam shape. Lastly, an ISTFT block 1028 may output the resulting flux beam.

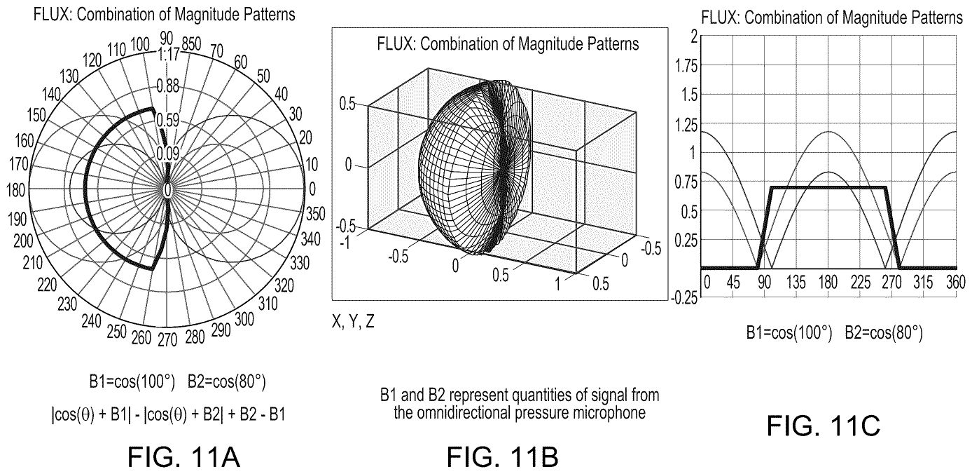

FIGS. 11A-C are plots depicting hemisphere beam forming in one embodiment. With a different selection of elemental hypercardioids, the result is a beam that is omnidirectional on one side and has zero response on the other. This shape was created by changing the notch angles to +/−100° and +/−80°. This creates a single omnidirectional lobe that is 160° wide and a rejection zone that is also 160° wide and with 20° wide transition zones. The ability to set the beam width arbitrarily with steep walls suggests that a binary search can be used for detection of the direction of signal source with a sequence of ever narrower beams rotated in a binary sequence of angles.

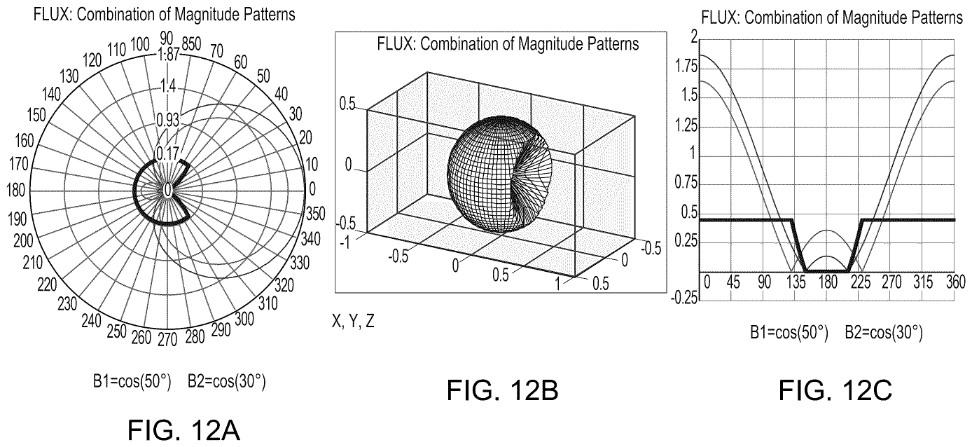

FIGS. 12A-C are plots depicting wide notch beam forming in one embodiment. This example is the complement of the first headlight beam. It is obtained by swapping the two B1 and B2 omnidirectional microphone signal quantities in the computation. This beam shows a perfect 60° wide notch with two 20° steep walls and omnidirectional response elsewhere over 260°.

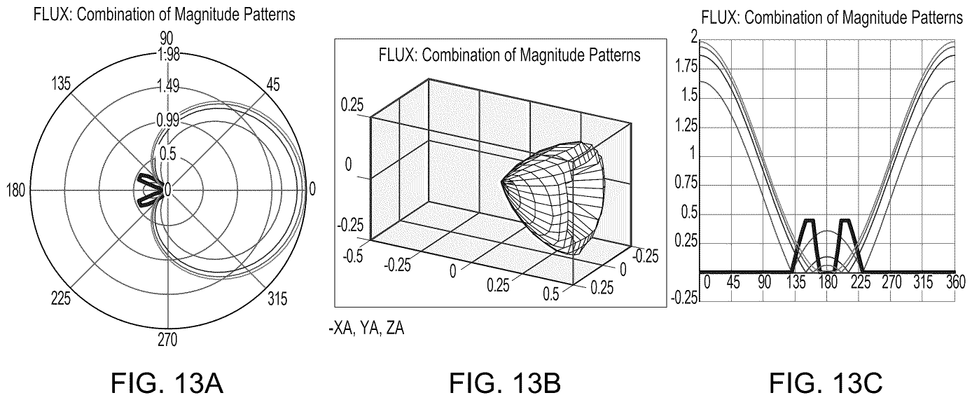

FIGS. 13A-C are plots depicting annular beam forming in one embodiment. This beam subtracts two headlight beams of different widths to create an annular beam with zero response inside and outside the ring. Note how the on-beam response in the annular ring does not change sensitivity within the ring. The annular beam could also be useful in arrays of 2 microphones that are mounted on a surface, where a sound slice is desired and there is no interference from above or below. This is one way to do broad fire as opposed to end fire.

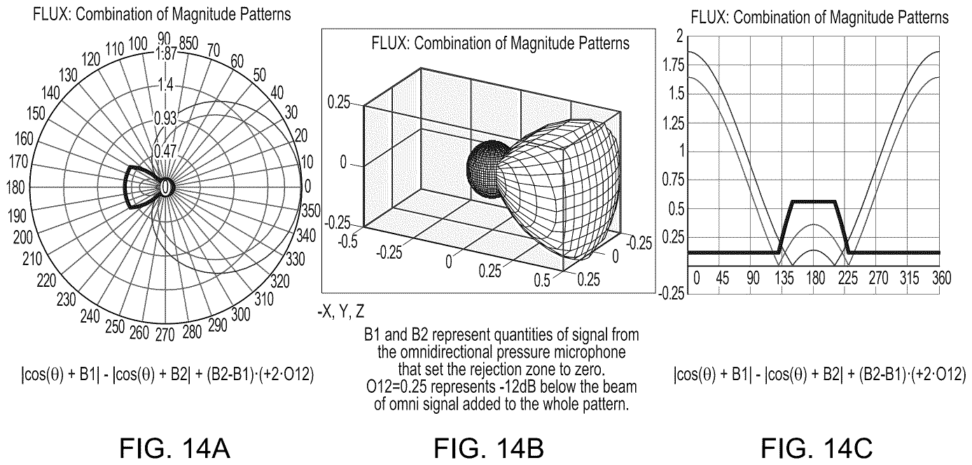

FIGS. 14A-C are plots depicting headlight beam forming in one embodiment. This example adds −12 dB below the beam of omni to the first headlight beam example. It is obtained by scaling the two B1 and B2 omnidirectional microphone signal scale factors in the computation. This beam shows two levels of omni reception, one inside the beam and one outside the beam.

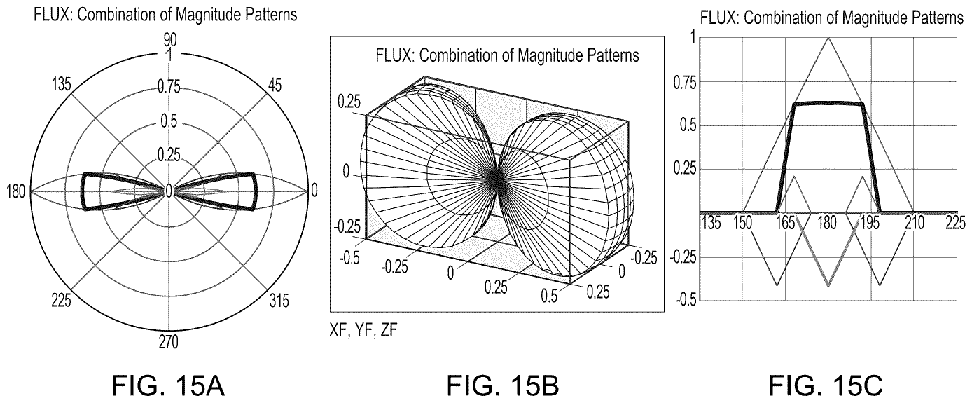

FIGS. 15A-C are plots depicting fan beam forming in one embodiment. This fan-shaped beam is made only with figure-8 flux signals, so it must be bidirectional. It uses 6 elemental clamshell beams with various amplitudes in various degrees of rotation about the Z-axis. The vertical cross-section pattern is a figure-8, which is the same as for the simple clamshell described above with reference to FIGS. 5A-C. The XY plot is horizontally zoomed around the lobe at 180° to show the elemental clamshell beam magnitudes and a nominal beam width of 30° with very sharp walls.

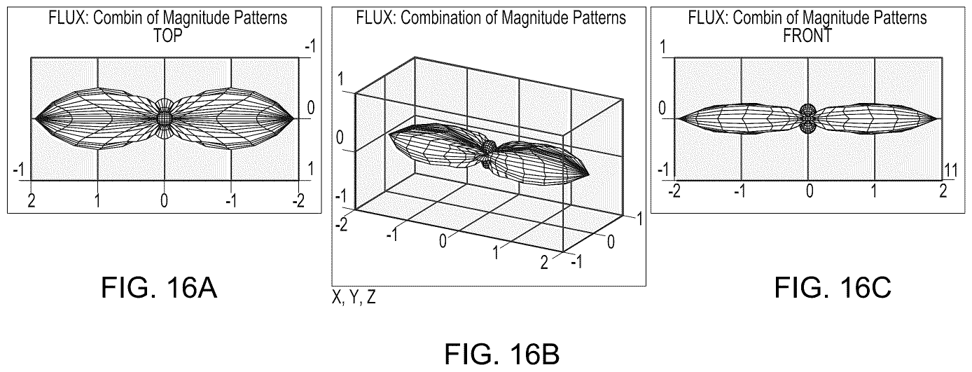

FIGS. 16A-C are plots depicting spear beam forming in one embodiment. This double-spear shaped bidirectional beam is made with a collection of 3 clamshell beams in various orientations. While it may not be optimal, it shows that a very sharp beam can be fashioned for direction finding applications.

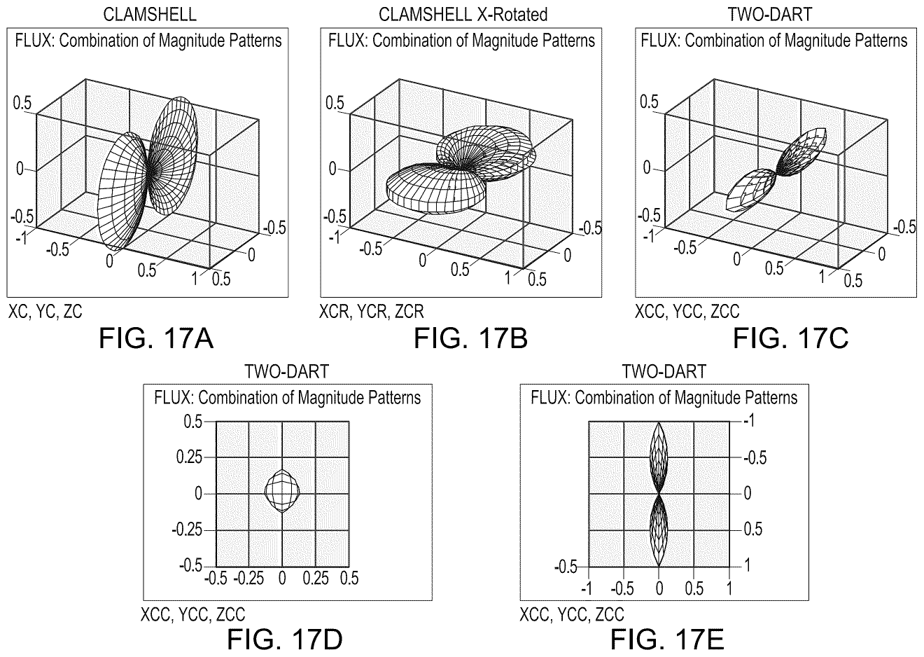

FIGS. 17A-E are plots depicting two-dart beam forming in one embodiment. Two bidirectional beams can also be combined with multiplication to obtain beams with a small cross-section that is common to both beams. The figures show the multiplication of two clamshell beams where one of them is rotated 90° about the beam peak. The result is a two-dart beam where the beam peaks are two sharp points. A square root may be applied after the multiplication to reestablish signal linearity, but for ranging and locating applications this is not necessary.

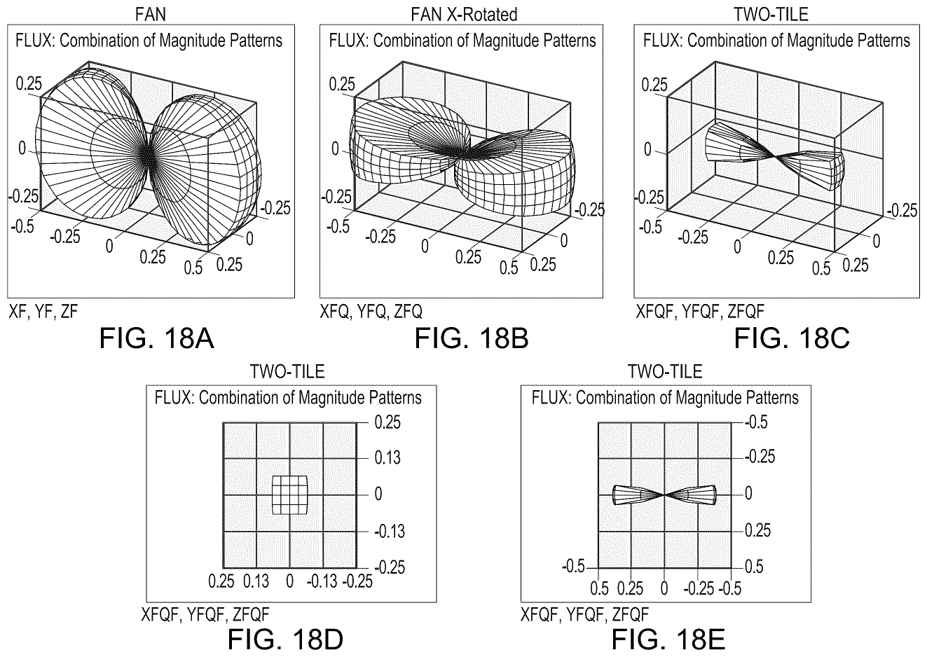

FIGS. 18A-E are plots depicting two-tile beam forming. Here, the multiplication of two fan beams is shown, wherein one of them is rotated 90° about the beam peak. The result is a two-tile beam where the beam peaks are two square tiles.

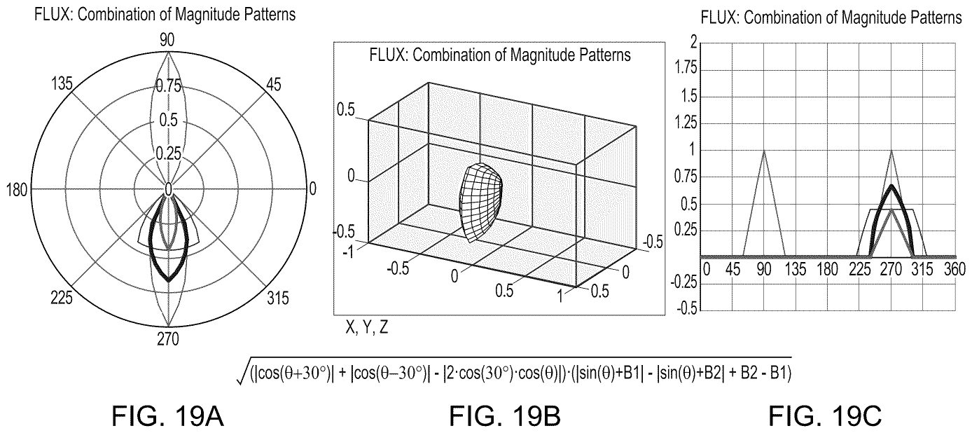

FIGS. 19A-C are plots depicting half shell beam forming in one embodiment. A bidirectional beam can be combined with a unidirectional beam to get some of the properties of both. The resulting beam is unidirectional, but has the high gain sharp peak that is possible with a bidirectional beam. The two beams are combined with a simple multiplication. An optional square root can be applied to restore linearity if desired. The 2D plots show the elemental clamshell beam in red, the elemental headlight beam in blue and the resulting sharp unidirectional beam in magenta without the square root factor and in black with the square root factor to restore signal linearity. The beam shown in 3D has restored linearity with the square root factor. This class of beam is particularly useful for direction finding and ranging applications. The version without the square root factor is particularly sharp for direction finding applications. Note in the 3D figure how the top and bottom of the half shell have been clipped by the conical shape of the headlight element.

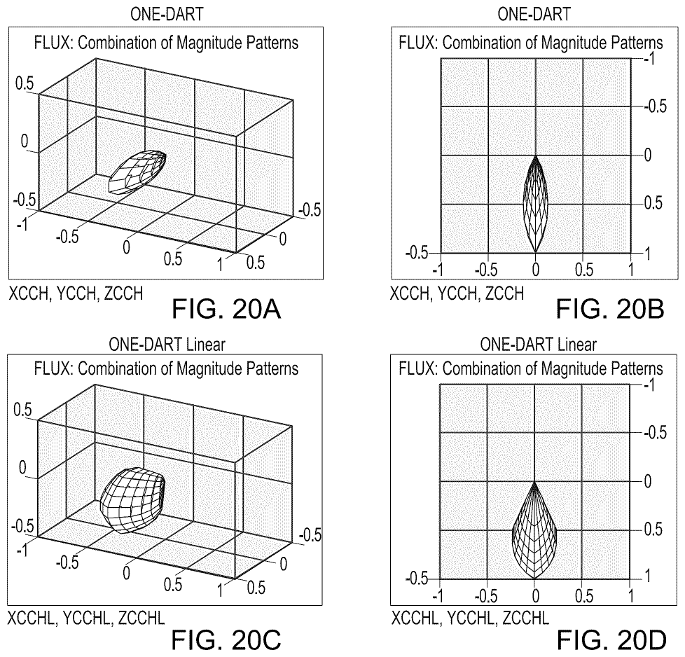

FIGS. 20A-D are plots depicting combined beam forming in one embodiment. The unidirectional dart beam show here is the result of multiplying beams shown in FIGS. 17A-E with a unidirectional headlight beam. The dart beam is shown here, but the same can be done with the tile beam.

Elemental figure-8 beams or pure cardioids can be multiplied together but because the elemental beams have no regions of pure rejection, the resulting beams always have lobes are not as useful as the beams realized so far with perfect cancellations through subtraction. If the nth power root to get back to a linear signal is not taken, the pattern is very sharp, which can be useful in direction finding applications.

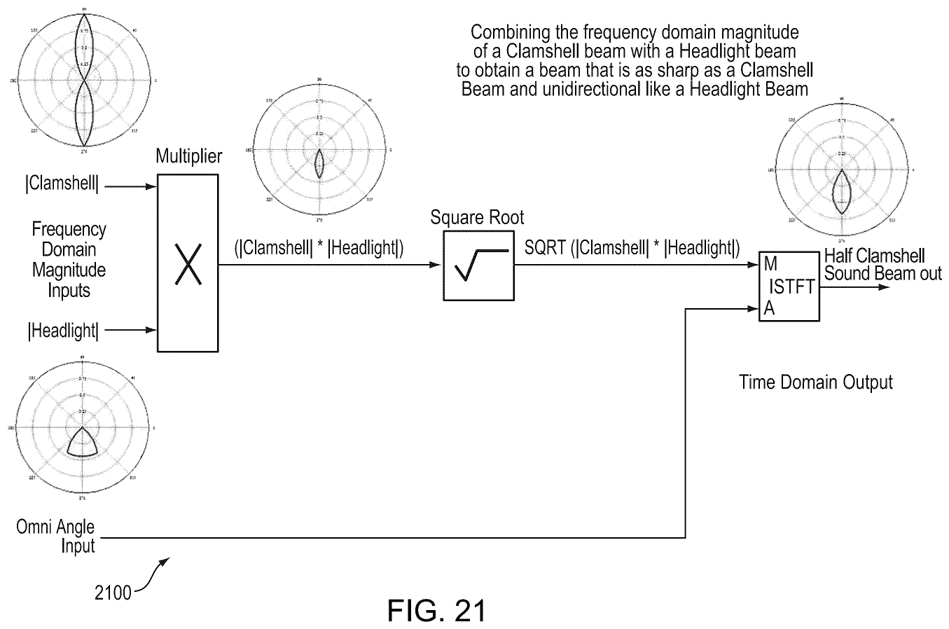

FIG. 21 is a diagram of a circuit providing combined beam forming, which may be implemented in the signal processor 620 described above. A multiplier may receive and multiply clamshell and headlight beams as frequency domain magnitude inputs, and generate a corresponding combined beam. A square root block may then perform a square root operation of the combined signal, and an ISTFT block may output the resulting half clamshell flux beam.

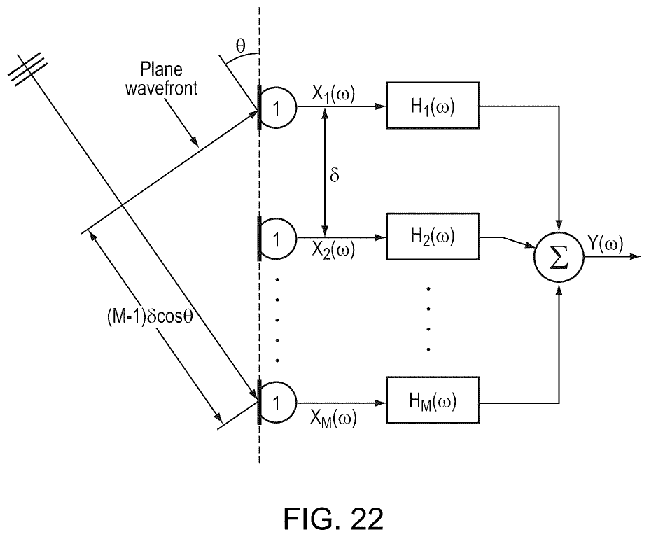

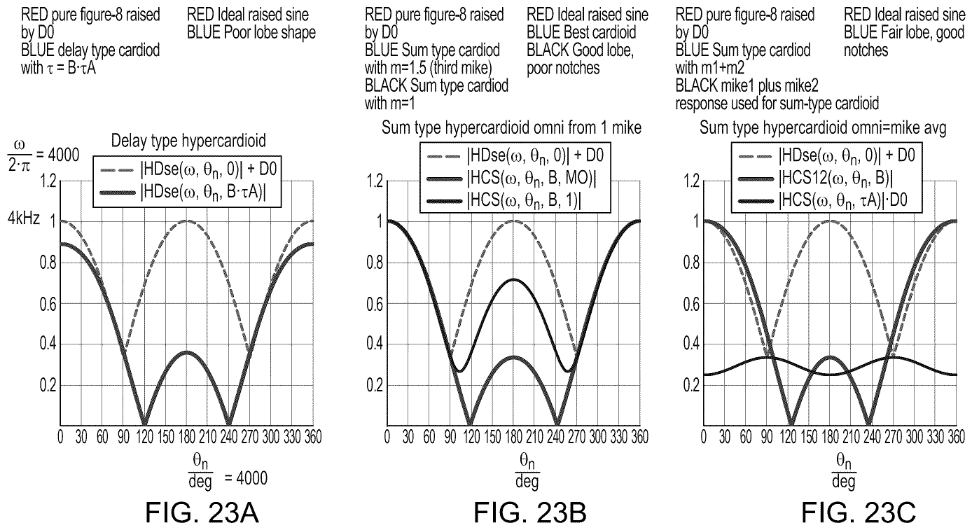

FIG. 22 is a diagram illustrating processing of sound waves via a microphone array in one embodiment. The sound velocity flux can be calculated as the spatial differential of the sound pressure at a given point. An approximation of this differential is a first difference between two points in space. This approximation of the velocity flux from the difference between pressures at two points may require frequency equalization for flat frequency response. Taking the velocity flux and sound pressure from the same set of microphones makes the pressure and velocity measurements highly correlated and reduces the effects of microphone mismatch.

Mems microphones make ideal point sound pressure sensors, because their mm scale is small compared to practical microphone pairs down to 1 cm and is also small compared to the wavelength of sound. A velocity-sensing mems microphone would then eliminate the need for the space of a 1 cm mems microphone pair and would eliminate the bandwidth limitations of a microphone pair. This would bring sound beam forming down to the milliscopic level and further increase immunity from any near field effects.

The mems microphone array model shown in FIG. 22, and basic equations as known in the art make a convenient model for beam forming calculations with a parallel flux. Experiments have shown very good performance in the near field down to 9 inches (23 cm). This means low sensitivity from pressure/velocity impedance variations and curvature of the flux.

See Messner, E 2013, “Differential Microphone Arrays,” Master's Thesis, Graz University of Technology, Graz, the entirety of which is incorporated herein by reference.

There are two fundamental methods to create an end-fire hypercardioid pattern. One method, which is most common in conventional beam forming is to add a process delay to one of the microphone signals before taking their difference. Another method which was first used to make cardioid microphones in the 1930's is to add the signal from a collocated omnidirectional microphone to a figure-8 velocity flux microphone. As will be demonstrated, the old method of adding omni to figure-8 has much wider bandwidth and much less beam degradation with frequency than the popular modern process delay method.

FIGS. 23A-C are plots depicting hypercarioid signals in one embodiment. The most important characteristic for flux beam forming is the back lobe conformity between the various elemental figure-8 or hypercardioid beam shapes. This ensures zero leakage in the beam rejection zone when the elemental magnitude shapes are subtracted. The back lobe in the following plots is at 0°/360°. 4 kHz is the aggressive test audio frequency that is nearly half the 8575 Hz half wave frequency of the microphone pair dipole separated by d=2 cm.

FIG. 23A shows the delay-type hypercardioid in the blue trace, which loses lobe conformity rapidly with frequency. In FIG. 23B, for omni-type cardioids with the omni content from a single microphone, the lobe conformity is good if one of the microphones is used, but the notch performance is poor in the black trace. The ideal omni source would be a third microphone located halfway between the two microphones with excellent lobe conformity over frequency and sharp notches in the blue trace. This is the best case. As shown in FIG. 23C, a good compromise between lobe conformity and sharp notches for the sum-type hypercardioid that does not require a third microphone. It obtains the omni signal from a sum of the two microphones as shown in the blue trace of the last plot. These effects all worsen with frequency. This example is at 4 kHz for a 2 cm microphone pair.

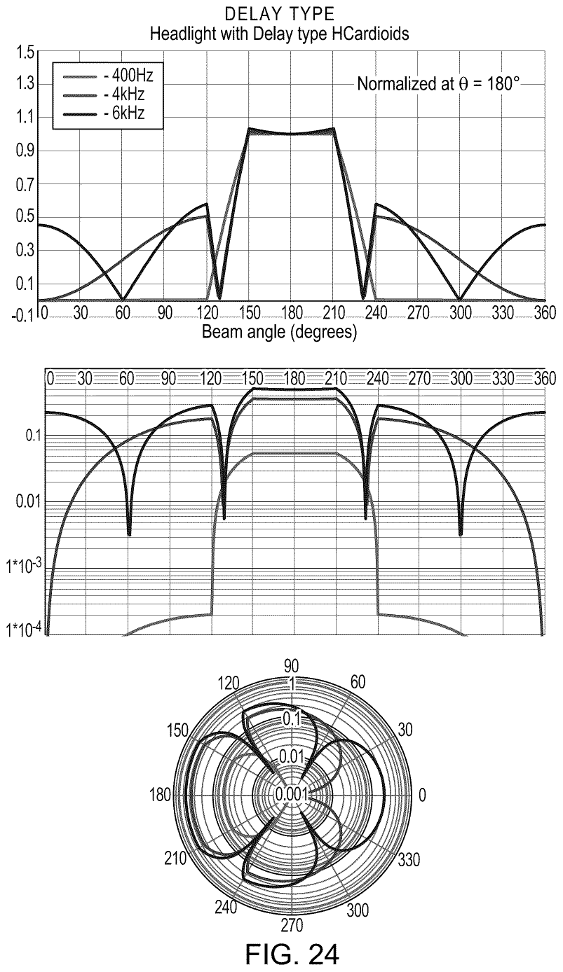

FIG. 24 is a set of plots depicting a headlight beam formed with delay type hypercardioid microphones in one embodiment. Headlight beam performance is directly related to the performance of the constituent elemental hypercardioid beams. The most common type of hypercardioid is made by adding a process delay to the difference between microphones. However, this type of hypercardioid degrades quickly with frequency and so does the resulting headlight beam as shown.

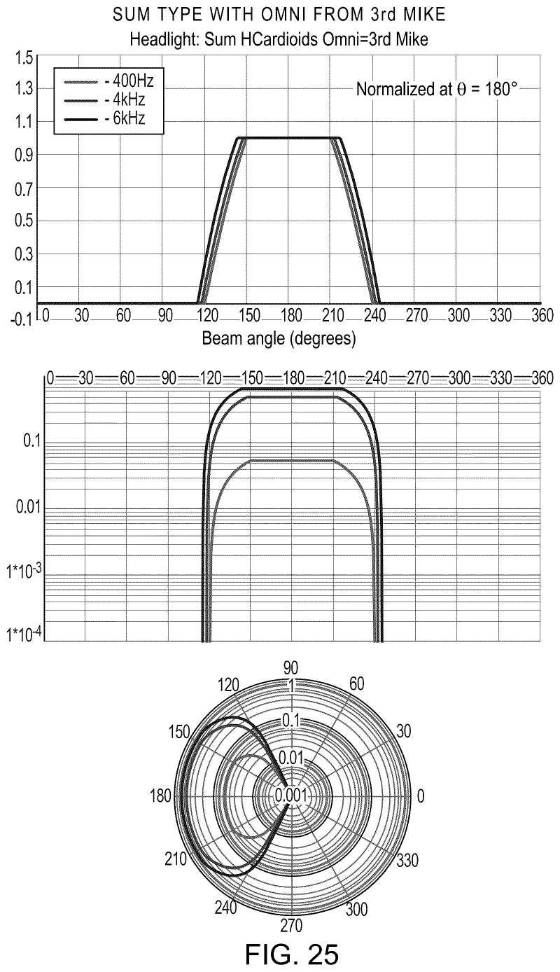

FIG. 25 is a set of plots depicting a headlight beam formed with sum type hypercardioid microphones in one embodiment. Sum type hyper cardioids are done by adding controlled and equalized amounts of omni signal to the straight figure-8 microphone difference. In the best case the omni content comes from a 3rd microphone place half-way in the microphone pair. The resulting headlight beams are virtually independent of frequency, even at 6 kHz with a half-wave frequency of 8575 Hz from a 2 cm microphone pair gap.

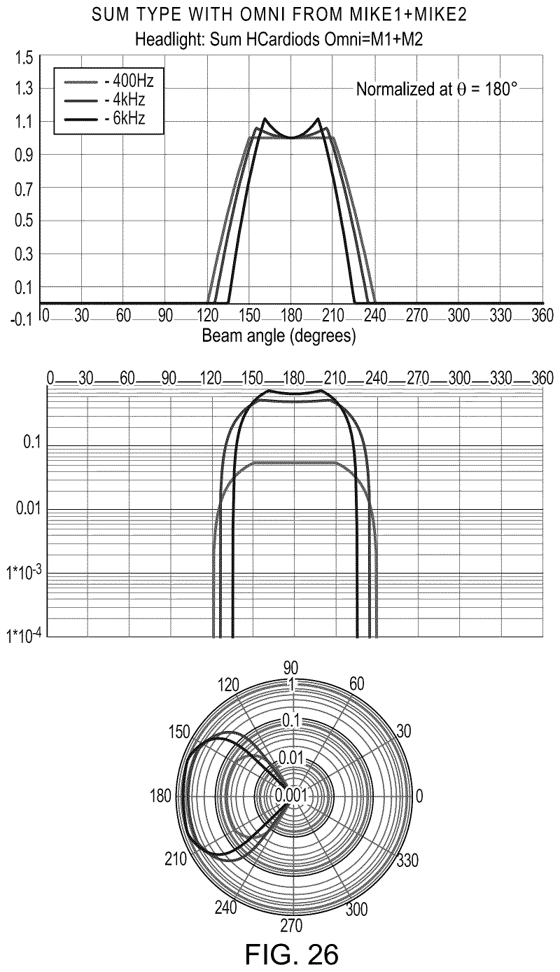

FIG. 26 is a set of plots depicting a headlight beam formed with sum type hypercardioid microphones in a further embodiment. A good compromise for the sum-type hypercardioids is to derive the omni content from the sum of the two microphones in the pair. note that there is no degradation at all off-beam with this compromise. The on-beam shape degrades only very slightly.

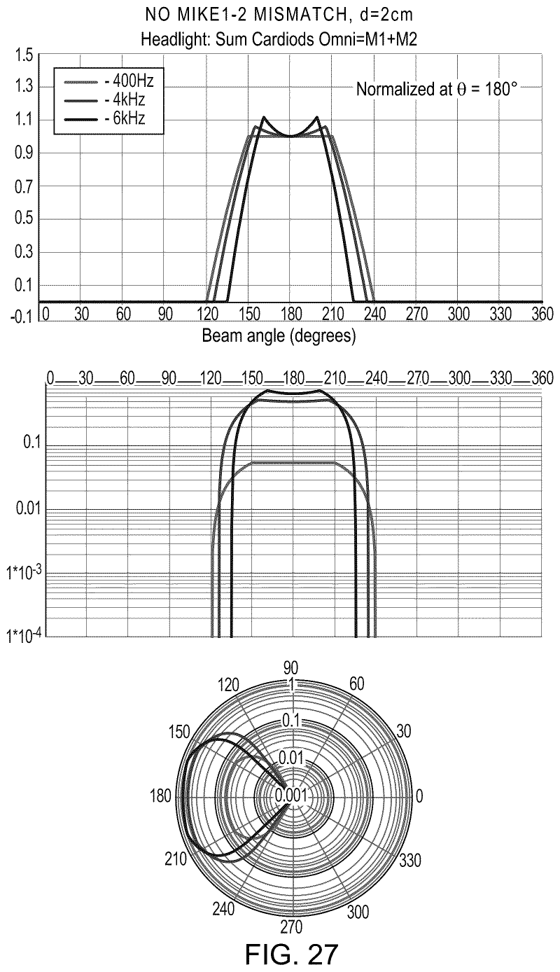

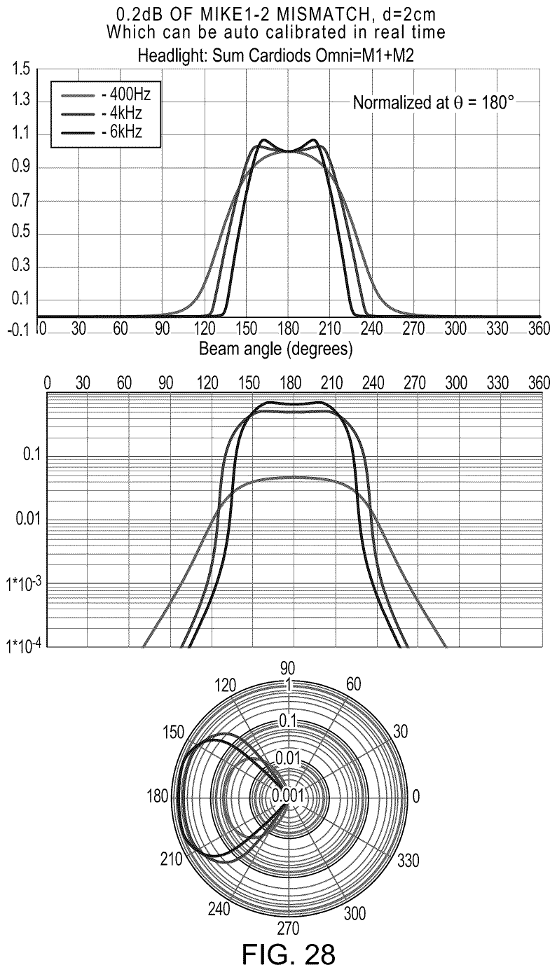

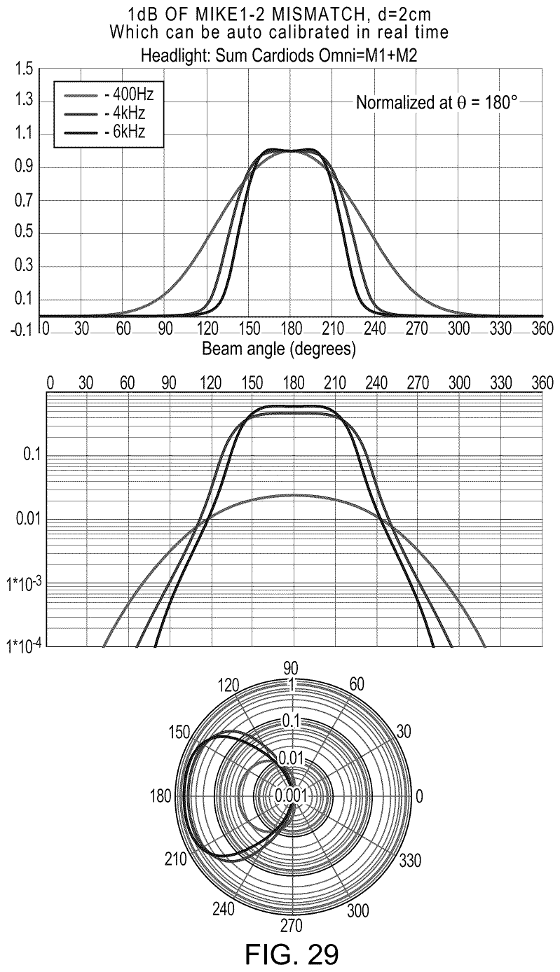

FIGS. 27-29 are plots depicting the effects of microphone mismatches. Headlight beams with elemental hypercardioids of the omni-sum type with the omni content taken from a sum of the two microphones M1+M2. There is negligible effect at high frequencies. Most of the mismatch effect is felt at low frequencies and results in a softening of the transition from on-beam to off beam. Note that no new back lobes appear.

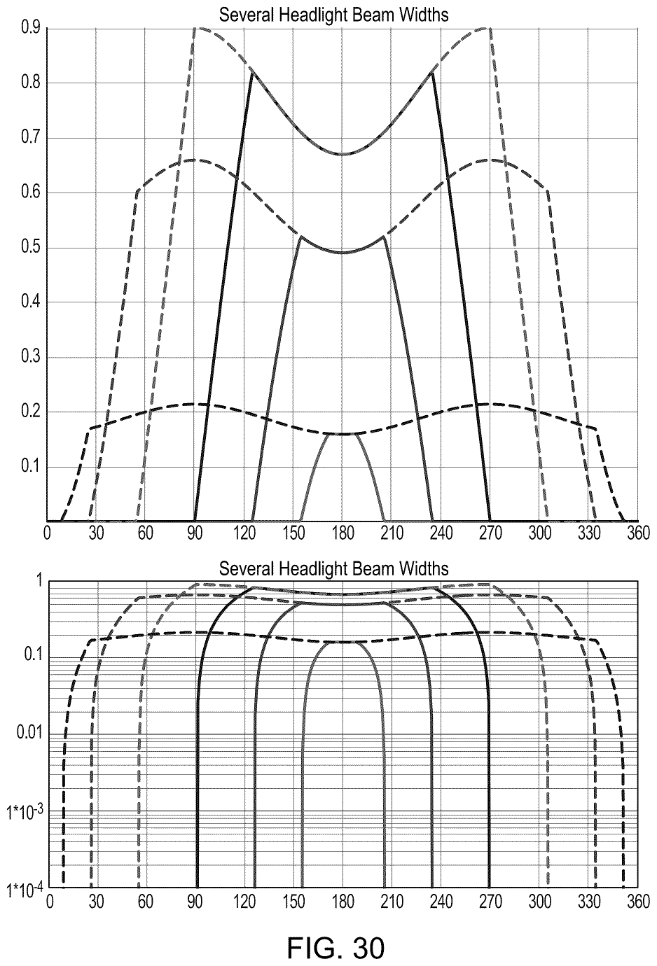

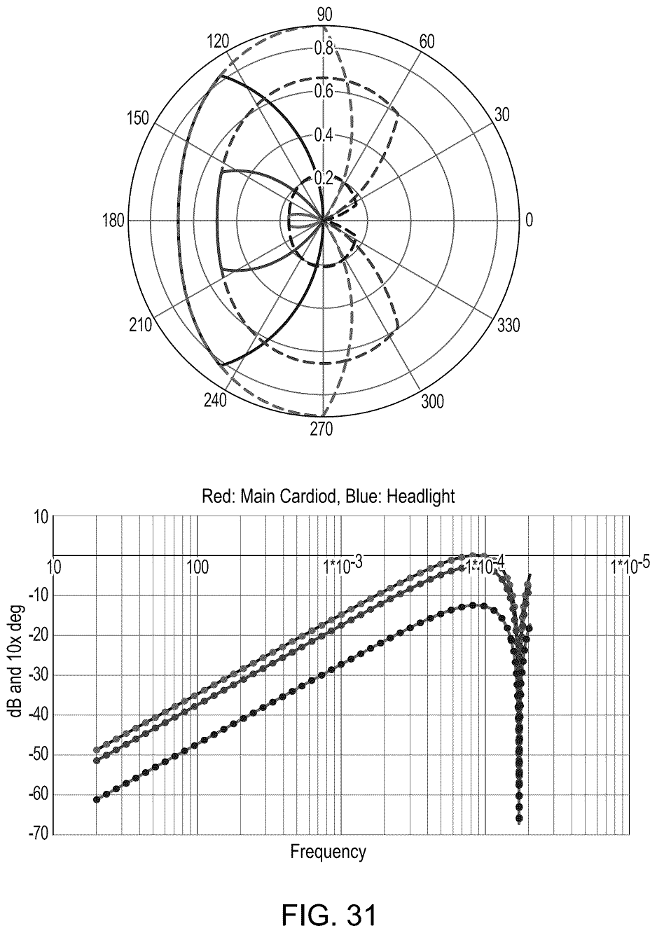

FIGS. 30-31 are plots depicting headlight beams via an elemental sum type hypercardioid with omni sum from two microphones. This beam exhibits high sensitivity, flat nose, and no leakage off beam. Frequency is indicated by the curve color as in FIGS. 24-29 (Red: 400 Hz, Blue: 4 kHz, Black: 6 kHz). Component cardioids show great lobe distortion at 6 kHz, but the distorted lobes match between the elemental hypercardioids so that the headlight is still flat without leakage. 30° skirts, except for widest and narrowest beams with 20° skirts.

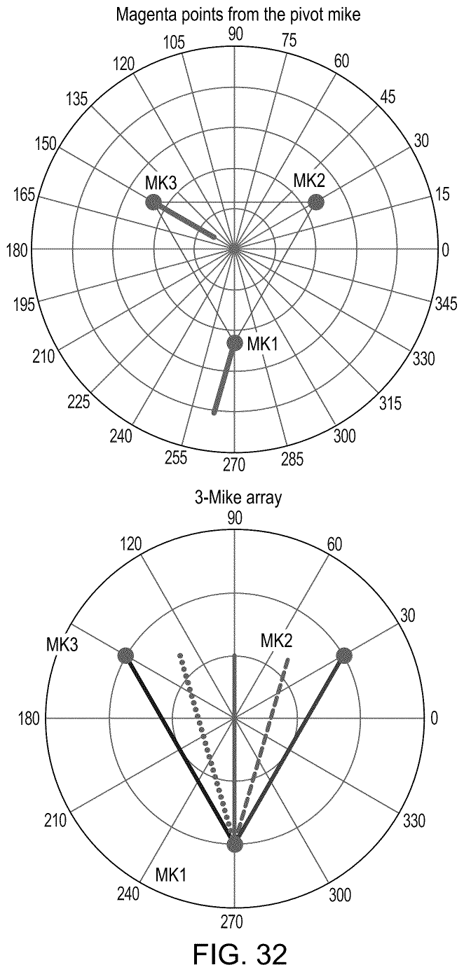

FIG. 32 is a set of plots depicting a 3-microphone array in an example embodiment. One additional microphone arranged in an equilateral triangle with the two-microphone array enables flux beam polar rotation on the plane of the triangle. Optionally, a fourth microphone above the triangle, arranged in an equilateral pyramid enables spherical rotation. Polar rotation in a plane is described herein, but the same principle applies for spherical rotation. Polar rotation of the flux beam is calculated with one microphone in the triangle serving as the pivot point and a virtual rotated microphone is obtained with interpolation between the other two microphones. The difference between the pivot microphone and the rotated virtual microphone creates a correspondingly rotated figure-8 flux beam.

This interpolation rotates the flux beam over a 60° range between the two microphone pairs with a common pivot microphone. The opposite direction is calculated by reversing the beam direction with a simple sign reversal to get rotation over the opposing 60° arc. Full 360° rotation is accomplished by changing the pivot microphone to the other two possible positions in the triangle. When a particular beam rotation is desired, the angle is quantized into 6 sectors, to select the pivot microphone, the beam direction and portion of 60° to be interpolated.

The top plot shows two examples of rotation. In one case the pivot microphone is MK1. The interpolated microphone rotates the beam −15° from the halfway point between MK2 and MK3 and the calculation further reverses the beam resulting in a beam pointing to 255°. In the other case, the pivot microphone is MK3. The interpolated microphone rotates the beam to the halfway point between MK1 and MK2 for a beam pointing to 330°.

In flux beam rotation all the rotational information is provided by the elemental figure-8 beams that comprise the desired beam. The most important figure of merit in the quality of the rotation is circular lobe conformity and symmetry in the elemental figure-8 patterns. This lobe conformity, as described above when comparing sum-type cardioids to delay type cardioids is essential to minimize response off-beam. The worst case for off beam response of a headlight shaped beam is with rotation exactly halfway between the two interpolated microphones. The worst case calculated off-beam response for a headlight beam with a 60° wide peak, formed with a 1 cm 3-microphone array, is at 1 kHz equal to −95 dB from the peak of the beam, at 4 kHz it is 70 dB and at 8 kHz it is −50 dB.

The bottom plot shows examples of rotation in 15° steps. These rotation examples will be used in the beam response plots described below.

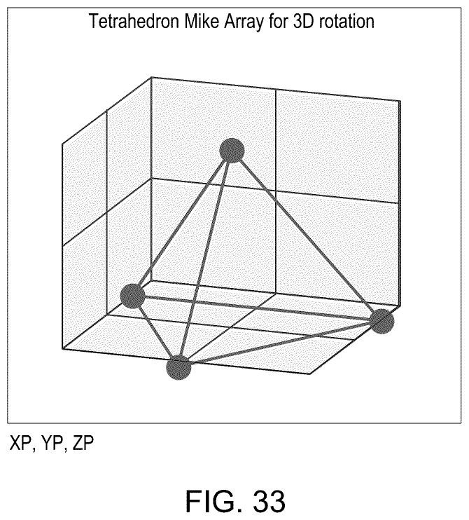

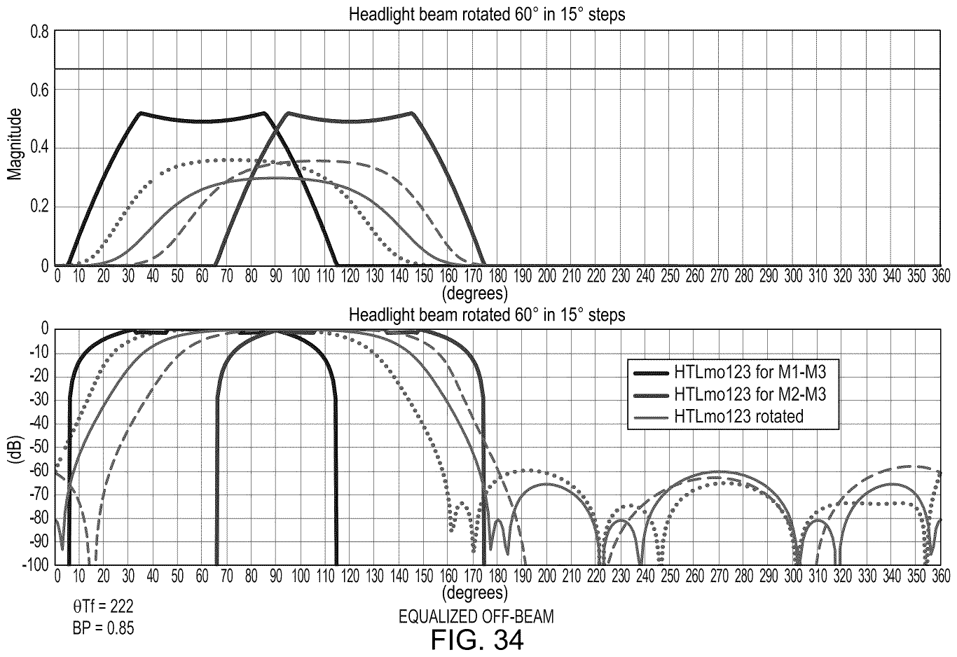

FIG. 33 illustrates a tetrahedron microphone array in an example embodiment. For 3D rotation a minimum of 4 microphones are needed to get rotation into the 3rd physical dimension. Most convenient and efficient is the regular Tetrahedron. However, any number of microphones greater than or equal to 4 that encompass a solid are capable of at least some practical rotation.

Smaller rotation artifacts are obtained by increasing the number of microphones. For example, the planar array should have an odd number of microphones disposed on a circle for simplest symmetric interpolations. A 5-microphone array on the vertices of a regular pentagon may require interpolation inside only 36°, which is nearly half the interpolation range of 60° for a triangular array. For the 3D array, the most convenient and efficient microphone arrays have faces that are all equal polygons with odd vertex count and with an opposing vertex centered on each face.

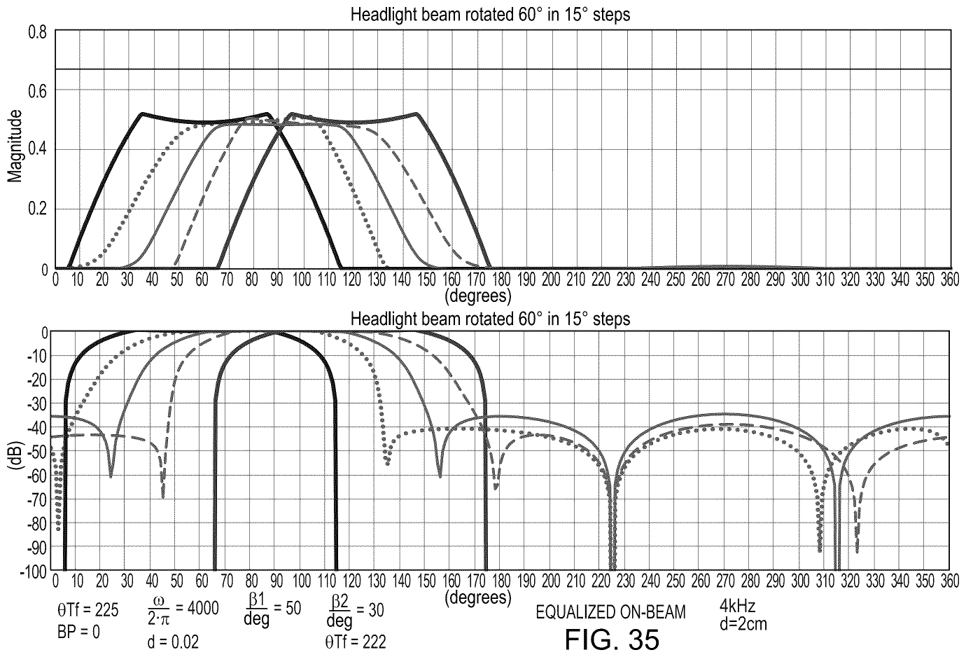

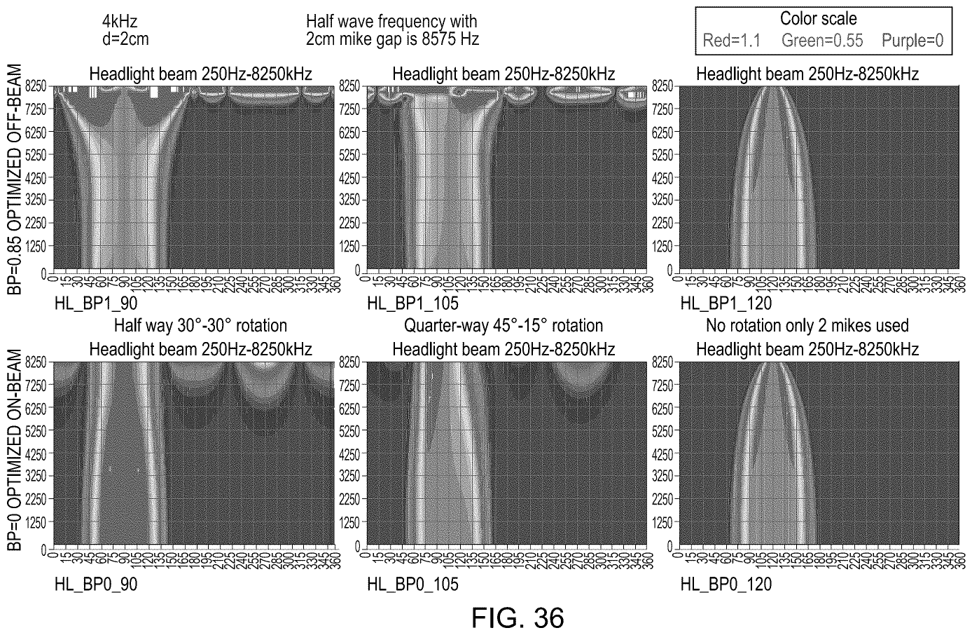

FIGS. 34-38 are plots depicting rotated headlight beams in one embodiment. For 3D rotation a minimum of 4 microphones are needed to get rotation into the 3rd physical dimension. Most convenient and efficient is the regular Tetrahedron. However, any number of microphones greater than or equal to 4 that encompass a solid are capable of at least some practical rotation.

Smaller rotation artifacts are obtained by increasing the number of microphones. For example, the planar array should have an odd number of microphones disposed on a circle for simplest symmetric interpolations. A 5-microphone array on the vertices of a regular pentagon may require interpolation inside only 360, which is nearly half the interpolation range of 60° for a triangular array.

With reference to FIG. 36, Frequency sweep surfaces for three rotations. First halfway 30°-30° rotation between 60° and 120°, to 90°, then quarter-way 45°-15° rotation to 105° and on the right no rotation at all with only 2 microphones in use at 120°. The first row of surfaces were optimized off-beam with BP=0.85. The second row was optimized on-beam with BP=0. Note how BP has no effect when only two microphones are used. The beam output is equalized to nominal sensitivity of 1 at center-beam. The color goes from violet=zero to red=1.1.

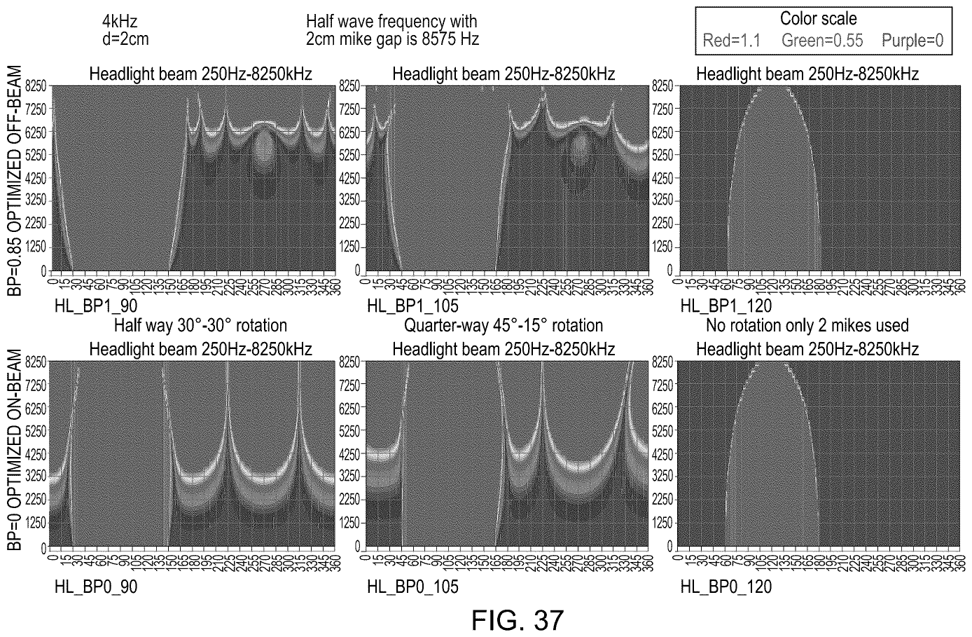

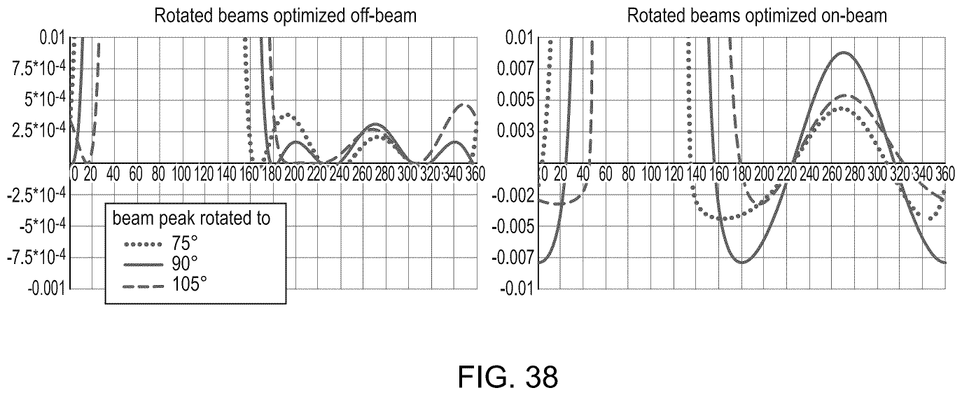

FIGS. 37 and 38 illustrate frequency sweep surfaces for three rotations. Now with the amplitude values clipped at 0.01 to show off-beam detail. Violet=0, Red=0.01 The off-beam performance is very good out to 6 kHz with a 40 dB rejection for both interpolated beams. The 2-microphone non-interpolated beam retains the expected infinite rejection off-beam. Shown in FIG. 38 is detail at 4 kHz of the off-beam region for BP=0.85 and BP=0 and three rotation angles in 15° steps, with the second angle at halfway interpolation.

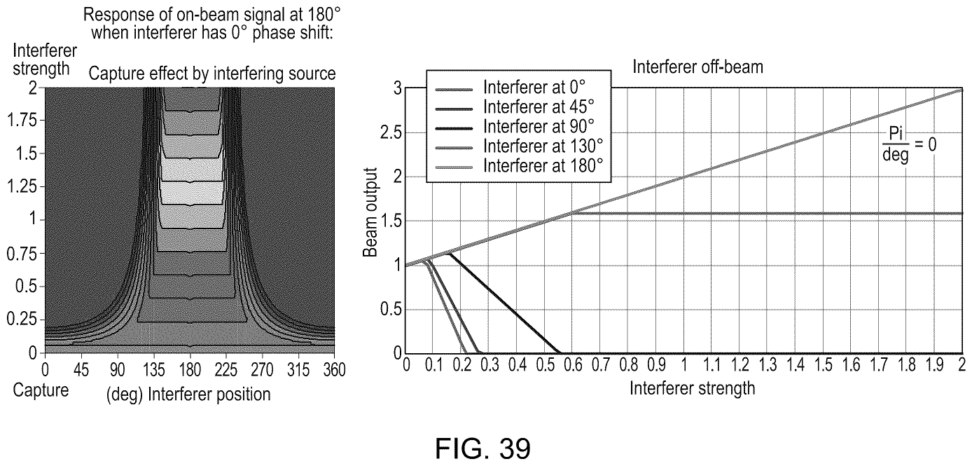

FIG. 39 is a set of plots illustrating a capture effect associated with a headlight beam in one embodiment. When signals in the same frequency bin come from on-beam and off-beam directions simultaneously, a capture effect results such that a strong off-beam signal may null the on-beam signal. The temporal phase difference between the on-beam and off-beam signals affects the sum of the two signals as received by sensors as expected. As different magnitudes are received by the elemental figure-8, hypercardioid or omni beam shapes, their sums or differences will have a necessarily different result than at the sensor, because only magnitudes without consideration to phase or polarity are used in the final beam shape calculation. This results in the capture effect.

Refer again to the plot of FIG. 9C depicting a headlight beam in a horizontal plane cross section. The beam peak is at 180° and is 60° wide. The beam base is 100° wide. The color contour plot of FIG. 39 shows the response of a signal with nominal magnitude of 1 aimed at the center of the beam in the first plot, while a second interfering signal in phase with the desired signal at the beam peak is swept around the sensors over 360°.

The horizontal axis shows the position of the interfering source. The vertical axis of the contour plot is the amplitude of the interfering signal, which ranges from 0 amplitude at the bottom of the plot to 2 at the top of the plot. The color contours represent the output signal, which ranges from 0 with dark violet to 3 in red. Cyan is 1. The second plot shows vertical slices through the contour plot when the interferer is at 0°, 45°, 90°, 130° and 180°. At 0° in the brown trace, the interferer is at the same angle as the desired signal and therefore adds to it directly. At 180° in the red trace, the interferer is directly opposite the desired signal at the back of the beam. The capture effect means that the stronger signal wins. If the off-beam interferer is strong enough, it will null the signal in the beam. The strongest capture effect is seen here when the interfering source is directly opposite the signal at 0°. With the interferer at 0°, it nulls (captures) the main signal with an amplitude of 0.22. Note the red trace intercept at the x-axis of the second plot. Phase shift between the off-beam interferer and the on-beam signal also softens the capture effect, so that the suppression is not complete.

The capture effect provides a further benefit: Any random microphone noise spectra that appears off-beam reduces the amount of random microphone noise that reaches the output beam. One simulation was done with a 1 kHz tone aimed at a microphone triad and a headlight beam with a 100° beam width at the base and a 50° wide top was calculated. Each microphone had a 20 dB SNR vs the 1 kHz tone. The simple sum of the three microphones yields a 24.8 dB SNR. The output beam showed a 30.1 dB SNR when the rotation used only 2 microphones and 25.8 dB when the rotation resulted in a microphone interpolated halfway between two microphones. This 5.8-10dB improvement over the noise of a single microphone was in part caused by the capture effect and in part caused by the beam forming that suppresses off-beam noise.

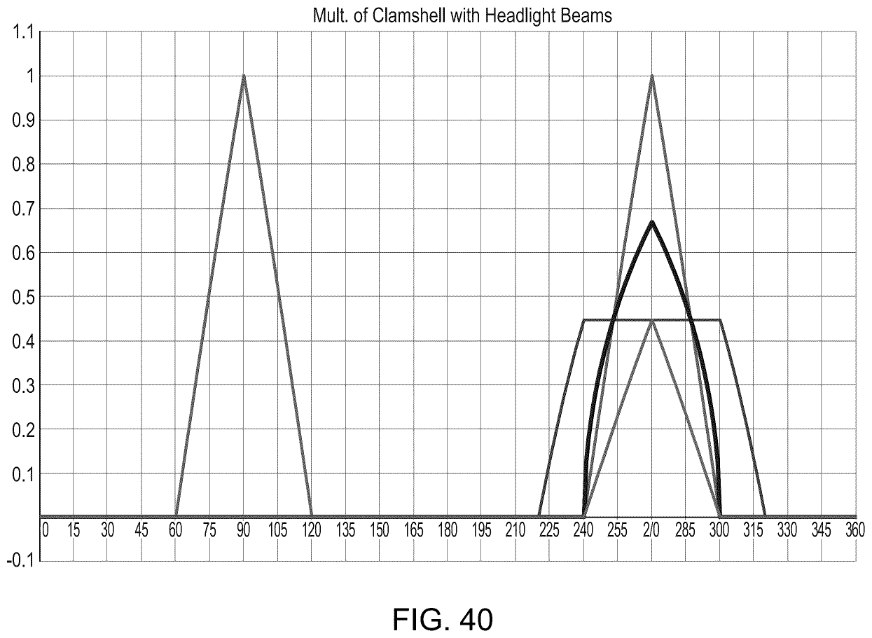

FIG. 40 is a plot depicting a multiplication of clamshell and headlight beam, comparable to the plot of FIG. 9C. In addition to the various beam types described above as inherently bidirectional or unidirectional, a third type of beam, described above, multiplies the magnitudes of these two beam types, still in the frequency domain, to produce a new type of beam that has qualities from both types of beams. The resulting beam is unidirectional but retains the sharp peak characteristics that are possible with bidirectional beams. A square root factor may be applied if signal linearity is to be retained, but at the expense of some dulling of the sharpness of the beam. The plots show the elemental clamshell beam in red, the elemental headlight beam in blue and the resulting sharp unidirectional beam in magenta without the square root factor and in black with the square root factor to restore signal linearity.

A new useful property of these beams is that multiplying elemental beams to form a new beam does not produce the capture effect that is inherent in the folding nature of the beam forming with scaled sums of the magnitude in the frequency domain that is used in the other types of beams. With beam multiplication, the off-beam regions have additional rejection that is the sum of the two beam rejections in dB. If the square root is necessary to preserve linearity, the off-beam rejection is still better than either elemental beam, but it is not the geometric average of the two beams. In dB, the off-beam rejection is simply the linear average of the two beam rejections. Off-beam rejection is a moot point with beams that are not rotated because their off-beam rejection is extremely high, theoretically infinite. But rotated beams have high, but not infinite off-beam rejection and benefit from the additional off-beam rejection that comes with beam multiplication.

If reducing the capture effect is desired, using diversity reception with microphone arrays placed a significant distance apart where the phase relations are different between signals in the same frequency bin that come from different directions.

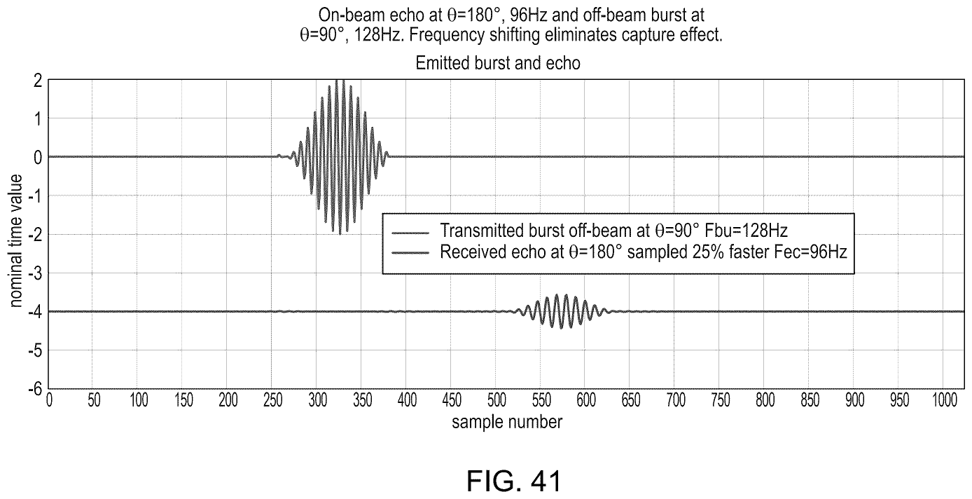

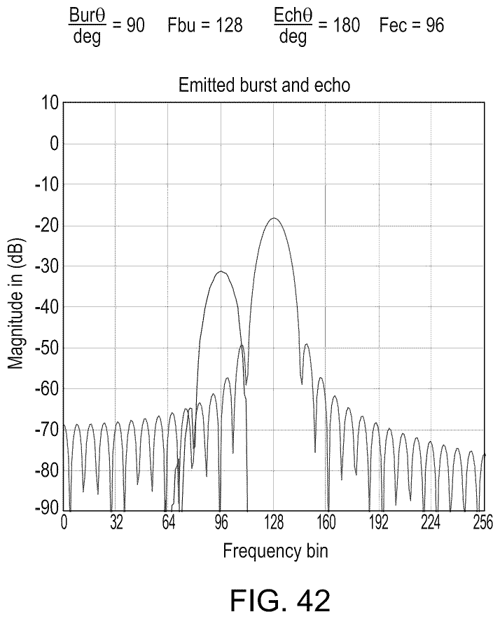

FIGS. 41-42 are plots depicting an emitted burst and echo in one embodiment. The capture effect has proven in tests to have an insignificant effect in audio speech applications because the off-beam sound sources are rarely at the same frequency or in close phase with the on-beam signal. The capture effect even has the advantage of suppressing speech reverberation that is weaker on-beam than off-beam. For ranging applications, however, the capture effect would cause an undesirable interaction between transmitted signals and the reflections being sensed, if these both fall in the same or overlapping STFT (Short Time Fourier Transform) records. The capture effect within in STFT record can cause an echo to be completely suppressed by the presence of the transmitted burst that is off-beam.

One way around this limitation in ranging applications is to shift the sample frequency during the collection record. One can simply have two sample frequencies with the lower sample frequency used during transmission and the higher frequency used during reception. This puts the transmitted and received signals in separate frequency bins. Smaller frequency shifts work too, but may be less convenient to realize. A further possibility is a continuous chirping of the sampling frequency, perhaps even with random sample dither or coherent sample dither. These techniques can be explored further.

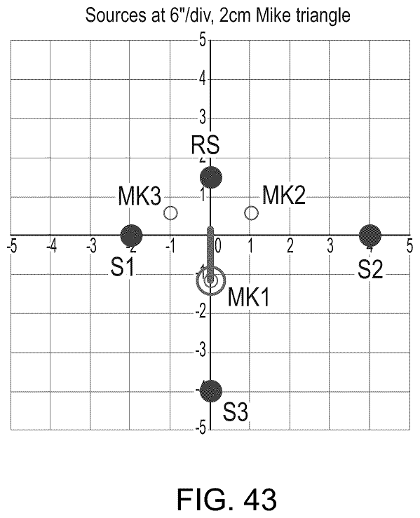

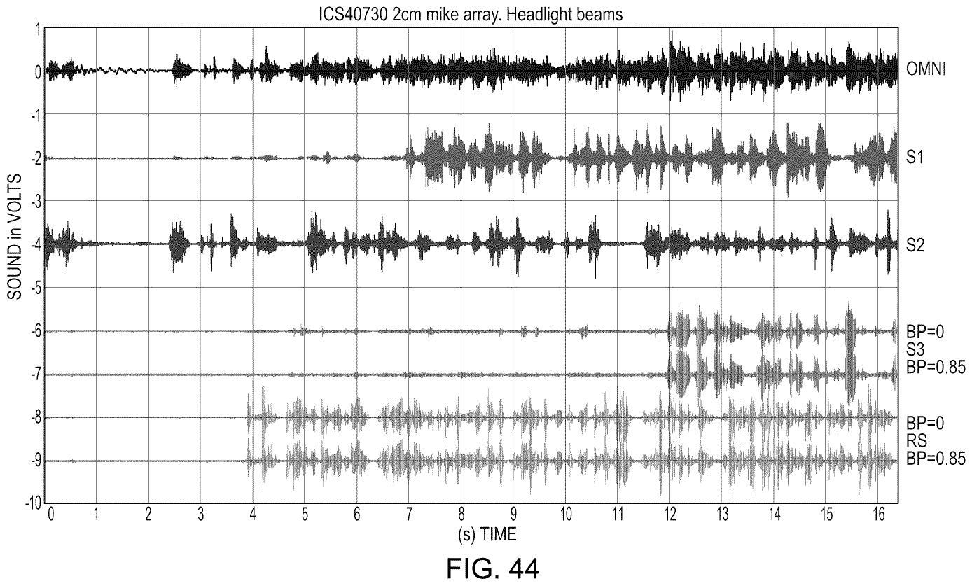

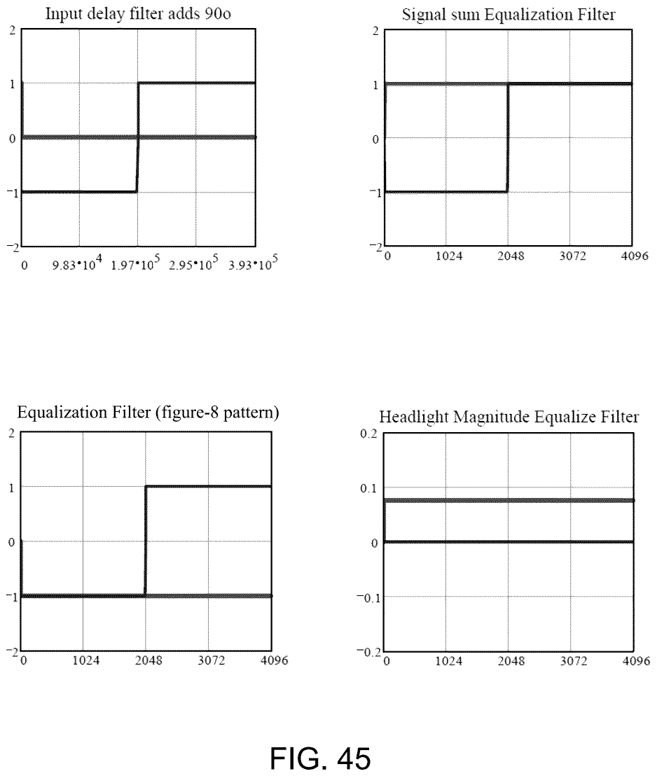

FIG. 43 is a plot depicting the position of multiple signal sources relative to a sensor array, and FIG. 44 is a plot depicting a set of signals detected by the sensor array shown in an example operation. The pivot microphone is circled in magenta, and the beam direction is shown as a magenta line. The sound sources are depicted as blue dots. Note that the RS microphone is only 6″ from the 2 cm microphone triangle, thus making it particularly challenging to block the RS source when the beam is aimed at S3. Both of these sources are located at beam locations that are interpolated 30° from the adjacent microphone pair. But the results when the beam is aimed at S3 are remarkably good, as described below.

In an example test of a sensor and source configuration as shown in FIG. 43, four voices laid out at 90° angles around a triangular 2 cm mems microphone array were recorded in the example configuration described herein. The recording surface was a fairly acoustically inert wool quilt on a bed. The room is 16′×14′ with 7.5′ ceilings and wood floors. The bed surface was raised 2′ from the floor. The wavefronts from the RS sound source arrive at the mems array with some curvature over the short 9″ distance, but no effect was detected in the results.

The recording equipment consisted of three InvenSense ICS40730 mems microphones on a 2 cm triangle in a 5 cm disk fed via the 16 cm ribbon cable and the 80 cm twisted pair to the microphone power box with two AAA cells. This connects via 6″¼″ shielded cables to the preamp and digitizer model iConnectAudio4 from iConnectivity. The digitizer connects via USB cable to the Surface GO tablet running the Reaper Digital Audio Workstation software. The DAW software collects the raw sound file, which is later processed with flux beam forming in my personal PC laptop with MathCAD 6.0.

The setup was calibrated for gain match with a 440 Hz tone radiated from a small self-powered speaker about one foot directly above the mems microphone array disk. The microphone mismatch was under 2% (0.2dB). This calibration step was not necessary as the results are indistinguishable with or without microphone gain calibration.

The headlight shaped beams were constructed from the difference of the frequency domain amplitudes of two hypercardioid beam shapes as outlined earlier. One hypercardioid has its notches at +/−50° and sets the 100° wide base of the headlight beam, giving a 260° off-beam region with extremely deep rejection. The other hypercardioid has a major lobe that closely matches the first hypercardioid to create the off-beam rejection zone. It has its notches at +/−15° and serves to create the flat peak of the beam that is 30° wide. The beam width is very non-critical with very similar results for substantially different beam base widths and flat top widths.

The S1 and S2 sound sources were aligned with the microphone 2-microphone3 dipole, so the headlight beam was calculated in opposite directions without rotation. The S3 and RS sound sources were aligned with microphone1 and halfway between microphones 2 and 3. This required maximal 30° beam rotation, which produces worst case headlight beam degradation at high frequencies as a result of the beam interpolation required by the rotation. The results however were still comparably good to the unrotated results for S1 and S2. In particular, the worst side lobe results described above (i.e., −35 dB at 4 kHz) is still far better than what is obtainable with standard phased array beamforming techniques.

When the beam is not rotated, only the signal from two microphones is used in the beam forming. The headlight shape is thus nearly perfect over a wide frequency band (refer to the frequency and angular sweep plots described above with reference to FIGS. 40-42) and is the best case for beam shape. The rejection in the off-beam region is theoretically infinite and in practice indistinguishably so. Rotated beams degrade at high frequencies, but can be optimized for on-beam shape or for off-beam rejection, or a mix of both. The results that extracted the S3 sound source with the 30° beam rotation between MK2 and MK3 showed an audible difference in the quiet passages when the rotated beam was optimized for best beam sharp edged shape with an off-beam rejection of only (<−35 dB@4 kHz) versus for maximal rejection (<−61 dB@4 kHz) (See FIG. 39). This difference is visible in the magenta traces of the time domain plot of FIG. 44, with the first magenta trace optimized for on-beam shape and the second magenta trace optimized for maximal off-beam rejection. The optimization for on-beam or off-beam response is done by selecting at what rotation angle θTf, is the frequency response of the elemental hypercardioids and the elemental omni sum calculated, which is then applied to the combination of the magnitudes of the elemental shapes.

For best on-beam shape, the frequency response for equalization of the hypercardioids may be calculated at the center of their minor lobes, which become the center of the (<180° wide) headlight beam. In the case of the 30° beam rotation/interpolation for the S3 and RS sound sources, the best on-beam response calculation is for angle θTf=90°. For best off-beam rejection, the rotation is selected to minimize the residual off-beam lobes. In this case the selected rotation for best off-beam rejection was at angle θTf=225°.

### Noise Reduction with Identical Sources

Two identical signals with uncorrelated noise can be processed by a headlight beamforming method, as described above, to produce an output result that has substantially less noise (e.g., −12 dB) than either source, or less noise (e.g., −9 dB) than the result of adding the sources (e.g., −3 dB). The only additional processing step is to delay one source with respect to the other to simulate the delay that exists between two omnidirectional sensors separated by a small distance when the sensors form an end-fire beam in line with the sensors. This is the case when Flux is estimated from the first difference between omnidirectional sensors. In the example described above, with two MEMS audio sensors, the half wave frequency corresponding to the 58.3 us over a 2 cm gap between sensors is 8.175 kHz.

When this delay is added to one of the two identical, but noisy, signals, the signals are comparable, in some respects, to the signals from the center of a beam formed with a 2-sensor array and a headlight beam calculation. While the identical signals appear to be at the center of the beam, the uncorrelated noise appears to be mostly off-Beam and is rejected by the beamforming process. This case is comparable to the case where a 2-sensor array is aimed at a desired signal, while receiving random noise from all directions. In this case the noise arriving from the far field at the two sensors is directionally correlated and is virtually identical, differing at each sensor only by a variable delay that is a function of the direction of the random noise.

### The Capture Effect on Noise Reduction

Despite the fact that the uncorrelated random noise of two otherwise identical sources is not exclusively directional, Headlight Beam forming processing can still achieve a noise reduction of −12 dB. This is because of the capture effect, whereby frequencies with signal arriving off-Beam subtract directly from the signal that arrives on-beam. The off-beam noise has the same spectrum as the noise that appears on-beam and gets captured. Thus, the on-beam noise is cleaned up by the off-beam noise. It is as if there were a conventional threshold type of frequency domain noise floor attenuation where the threshold is the off-beam noise. In the Headlight calculations, there is no noise estimate, and the capture effect tracks the off-Beam noise level which matches the on-beam noise being rejected.

This behavior means that the −12 dB noise reduction will occur regardless of the noise level and regardless of the spectral contour of the noise. The spectral contour of the noise must still be substantially similar in both sources for optimal noise rejection. A noiseless signal will be processed with zero effect on the signal, regardless of how weak the signal is. The effectiveness of this noise reduction relies on the desired signal frequencies being significantly stronger (e.g., by >6 dB) than the random noise floor, so that they only suffer a mild reduction. If the desired on-beam frequency is at the same level as the off-beam noise frequency, it will be substantially suppressed. The noise floor is a direct function of the length of the Short Time Fourier Transform STFT, and therefore the longer the STFT, the lower the noise floor. This lower noise floor then lets weaker on-Beam signals pass with less capture effect attenuation.

In an example embodiment, this noise reduction method may be applied to a noisy FM-Stereo audio signal coming from two identical tuners. The left channel of one tuner was processed together with the left channel from the other tuner. The same process may be applied for the two right channels, thereby preventing alteration of the stereo image. In a further example, noise reduction may be applied to noisy recordings where half of each track is read by two independent sensors. With additional synchronization overhead, two identical, but noisy, recordings can be cleaned up. This noise reduction can be applied to any pair of signals, including audio, image or radio frequency (RF) signals.

### Simplified Equalization for Noise Reduction

FIG. 45 is a series of plots showing the filter coefficients from different filter stages of processing in one embodiment. The artificial delay that is added to one of the identical, but noisy, signals does not have to be a fixed time delay. The application of the delay and subsequent equalization filters are greatly simplified if the fixed time delay is replaced with a fixed phase delay of 90° between the signals. Now all complex filter coefficients have real and imaginary values of 0 or +/−1 as seen in FIG. 45. The plots of FIG. 45 show the coefficients of the various filters with the blue trace showing the imaginary component and the red trace showing the real component.

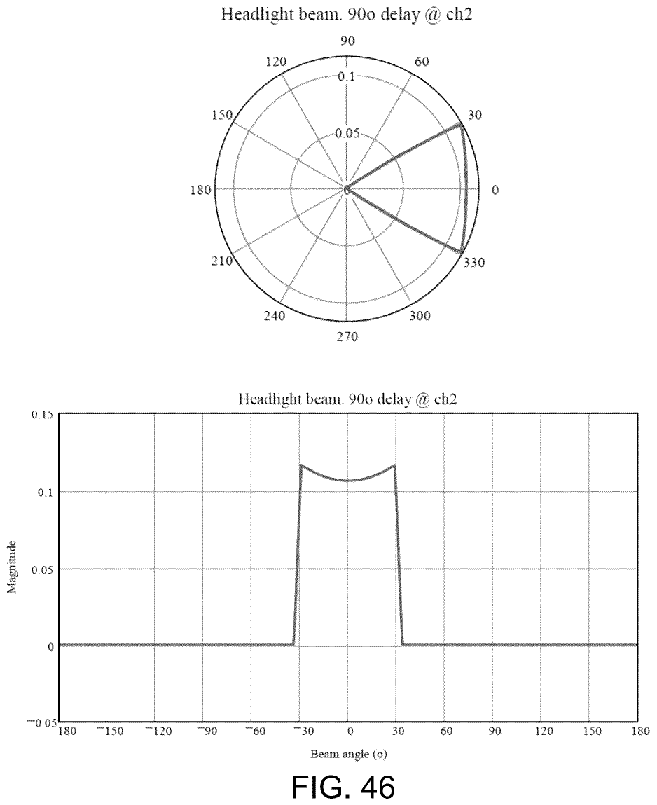

FIG. 46 are polar and cartesian plots showing a Headlight Beam with the aforementioned delay. As shown, the 90 deg phase delay filter produces a small dip at the center of the Beam. With a fixed phase delay, the noise reduction also becomes independent of frequency, with the Headlight Beam maintaining the exact same shape at all frequencies. The optimal Beam width for noise reduction is β1=40 deg at the base of the Headlight and β2-35 deg at the top of the Headlight. This reduces musical noise artifacts to a minimum, while reducing noise by −12 dB.

### Noise Reduction with Two FM Stereo Tuners

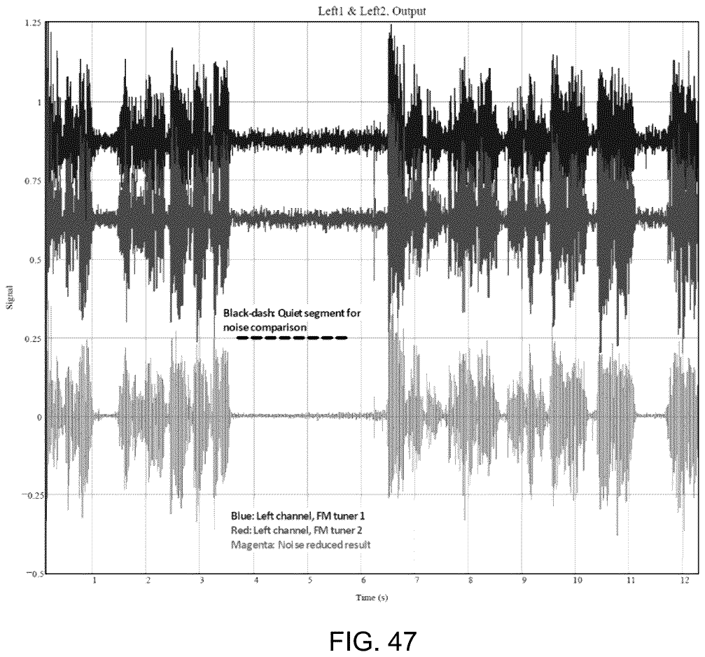

FIG. 47 is a plot of a 12.3-second audio clip illustrating noise reduction in one example, with the left channel from tuner 1 as the first trace in blue and the left channel from tuner 2 is the second trace in red. The two signals come from two identical ICstation FM tuner modules, that are tuned to the same station and same volume level with a volume match that is better than 0.1 dB. The source material is the voice of the announcer. The noise-reduced result with Headlight Beam processing is shown in the third trace in magenta. The two right channels were processed independently with the same procedure, and the stereo separation remains unaffected.

The dashed black line marks a quiet 2 sec segment where no voice is heard. The −12 dB noise reduction can be readily seen in the third trace and heard in this quiet section. This segment was also used to qualitatively compare the random noise content of the two input left channels with the noise-reduced output.

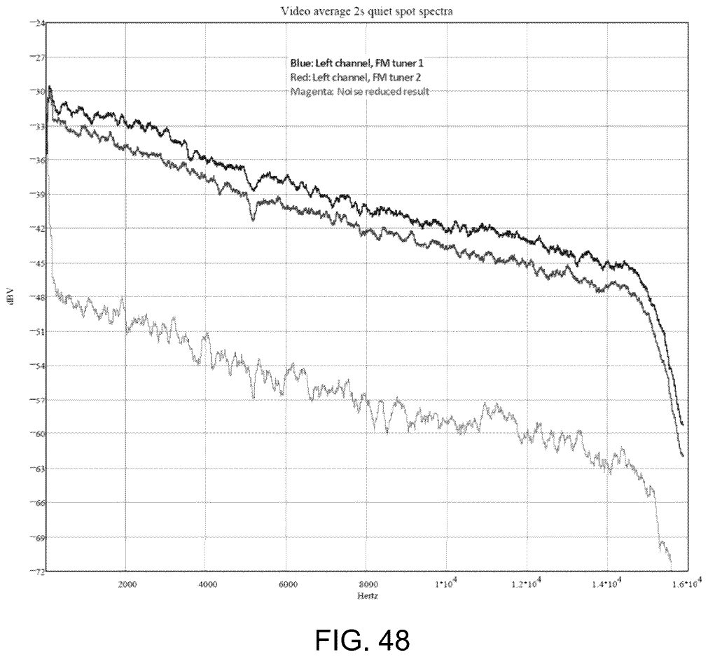

FIG. 48 is a frequency spectrum plot corresponding to FIG. 47. Here, it is shown that the quiet 2 sec section with 64 k samples of the signals as the time domain plot that is marked with the dashed black line. The tilt in the noise spectra is produced by the tuners as part of the FM detection deemphasis filtering and is inconsequential to the noise reduction because the noise reduction is done one frequency bin at a time and the spectral contour of the noise is substantially the same for both sources. The spectra were smoothed with a boxcar filter that is 256 frequency bins (125 Hz) wide before the dB calculation was applied for display. The smoothing filter caused the spike in the magenta curve at 0 Hz.

Note that noise from tuner 1 is 1.8 dB higher than the noise from tuner 2. However, the noise reduction is still substantially effective, with a 12.3 dB noise reduction from the worst of these two sources. Unlike with conventional linear diversity reception for coherent noise reduction, which requires an amplitude and phase match in the signals for noise cancellation through simple subtraction, the noise match is not critical with the Headlight Beam noise reduction.

### Headlight Beamforming with First Difference Flux Estimate

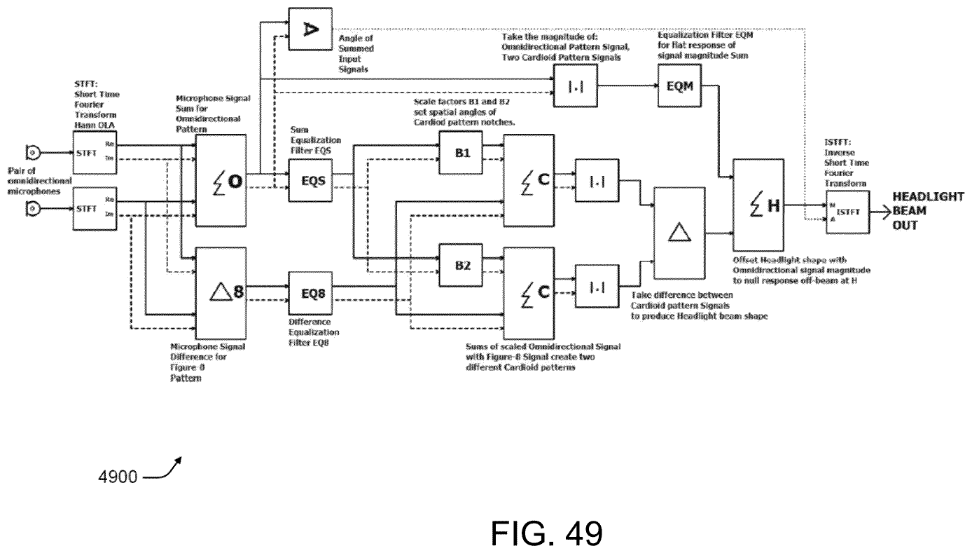

FIG. 49 is a flow diagram depicting a Headlight Beamforming process 4900 in one embodiment. In particular, this example is an audio flow graph for Headlight flux Beamforming with the velocity flux estimated from the first difference of the pressure signal from two omnidirectional microphones. Each block may correspond to a discrete circuit element, or a function performed by a signal processor. The Beam Forming Flux can be estimated as the first difference of the related quantities of the electric field for electromagnetic fields or the pressure field for sound.

The process 4900 is an example of Flux Beamforming applied to audio signals. It shows two pressure sensitive omnidirectional microphone inputs. In this example, the STFT is performed at the microphone sensor outputs. The STFT blocks drive a sum block that adds the two microphone signals to provide the omnidirectional signal sum. The STFT blocks also drive a first difference block to create the figure-8 Flux pattern estimate. The outputs of these blocks are equalized with frequency filters EQS and EQ8. Additionally, the angle is computed from the sum signal and fed forward to the end of the process.

Following the sum-type method described above, the two cardioids with different notch angles are created in the summation blocks marked C with the addition of the equalized figure-8 pattern with two differently scaled amounts, B1 and B2, of the equalized sum signal.

The location of the notches is set by the scale factors B1 and B2, which are the cosines of the cardioid notch angles β1 and β2. The beam width is twice these angles.

The difference of the cardioid magnitudes in the Δ blocks, plus an equalized magnitude of the sum signal, are added in the last Σ block to create the Headlight Beam at H. An ISTFT combines this magnitude result with the angle of the sum signal to create the time domain Headlight beam output.

### Noise Reduction of Two Sources Via a Headlight Beamforming Process

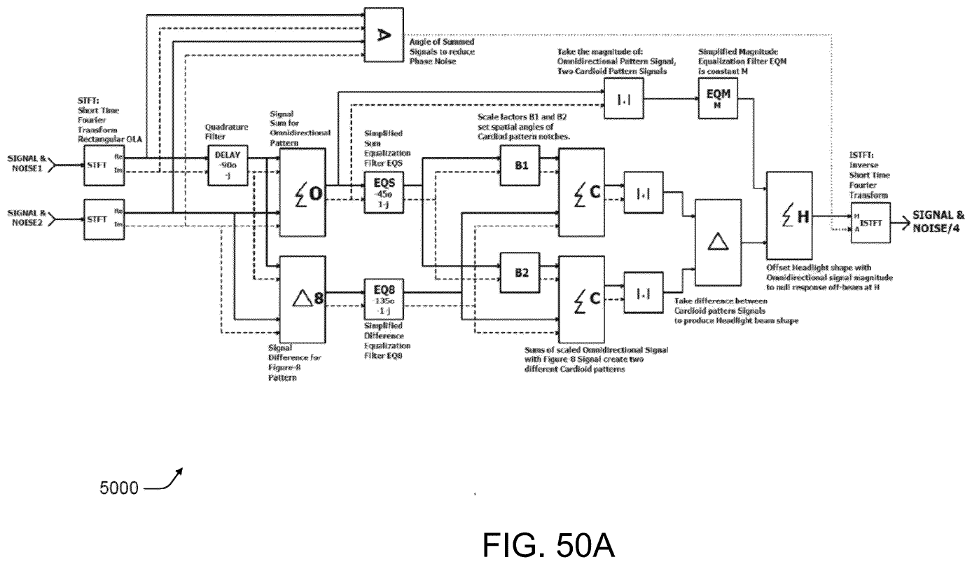

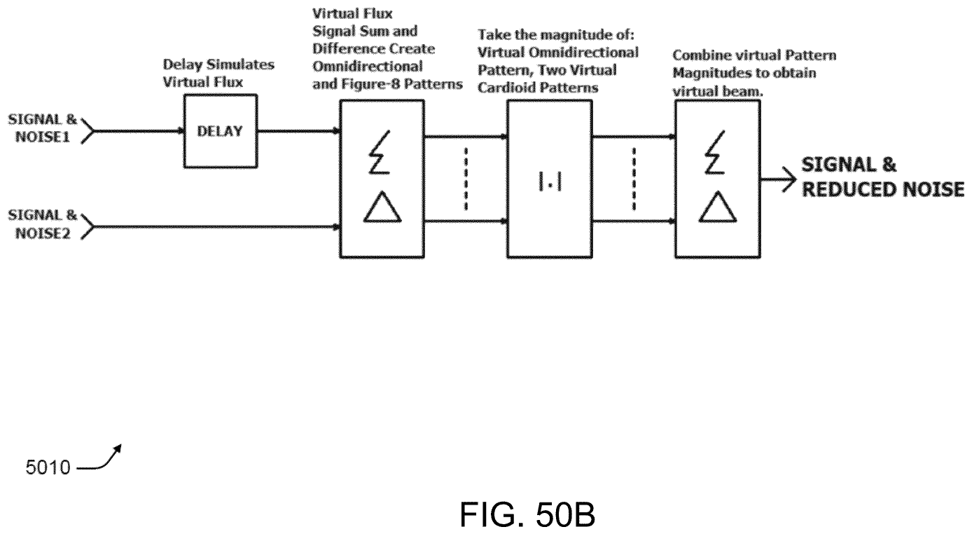

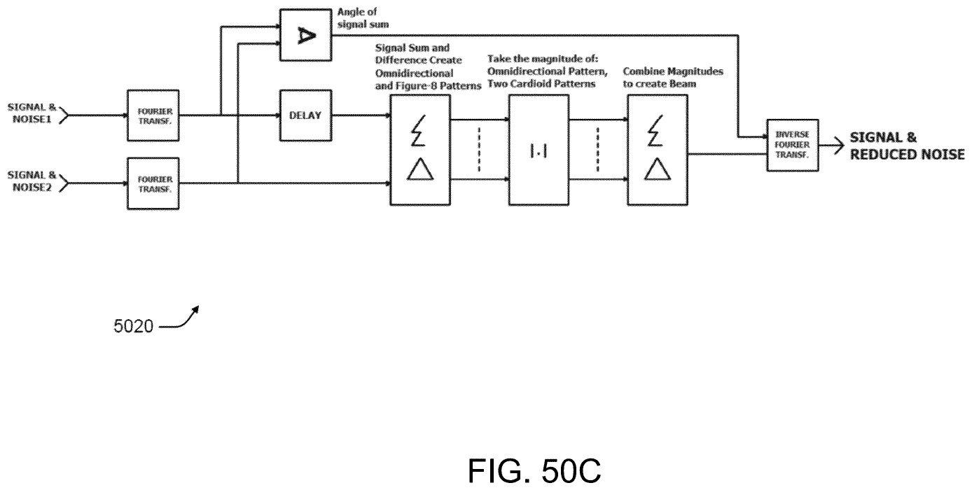

FIG. 50A is a flow diagram depicting a Headlight Beamforming process 5000 in one embodiment. Each block shown may correspond to a discrete circuit element or a function performed by a signal processor. In this example, a first difference virtual flux is estimated from omnidirectional sensors. When applied to noise reduction, this process takes two identical, but independently noisy signals (SIGNAL&NOISE1 and SIGNAL&NOISE2) to reduce their uncorrelated noise by −12 dB. In comparison with the process 4900, the process 5000 introduces of a −90 deg phase delay in the SIGNAL&NOISE1 path. After that, the sequence of blocks is the same, except that the equalization filters EQS and EQ8 are now simplified into coefficients of +/−1 and +/−j as shown in the plots in FIG. 45. These coefficients avoid the need for multiplication as simple sign changes and Real/Imaginary signal swaps realize the filter function computations. The last filter EQM reduces to a simple scale factor M. The output delivers the desired SIGNAL with one quarter of the original noise for a 12 dB improvement in SNR.

The STFT may use a Hann window with 50% Overlap-Add (OLA) FFT input records. Any residual noise artifacts can be further reduced by eliminating the Hann window and simply using the default rectangular window with the same 50% OLA. The SNR also improves about 0.5 dB with the rectangular window in simulation. The reason for both of these improvements is that the residual noise from each of the two rectangular window OLA sequences is more uncorrelated than with the Hann window, which ends up overlapping less signal at any one point in time.

A further simplification to the process 5000 is possible by eliminating the OLA process in the STFT altogether, so that a single contiguous non-overlaping Fourier transform sequence is used. This incurs a modest reduction in noise improvement and slightly more noise artifacts. It is possible to combine 4 noisy signals by first cleaning up 2 pairs of these with the Headlight Beamforming and then this pair of cleaned up signals can be processed again with the Headlight Beamforming for a net SNR improvement of 24 dB.

FIGS. 50B-C depict further noise reduction processes 5010, 5020 that incorporate simplifications over the process 5000 such as those described above. In particular, the process 5010 depicts a noise reduction process, as applied to two matching signals with uncorrelated noise, as follows:
a) A delay is applied to the first input signal.
b) A virtual flux signal sum and difference create virtual omnidirectional and figure-8patterns from the delayed first signal and the second signal.
c) A magnitude is taken of the virtual omnidirectional and figure-8 patterns.
d) The virtual pattern magnitudes are combined to obtain a virtual beam, which corresponds to a noise-reduced version of the input signals.

The process 5020 is comparable to the process 5010, but further incorporates Fourier and inverse Fourier transformation as described above with reference to the process 5000.

### Noise Reduction with Two Noisy Images

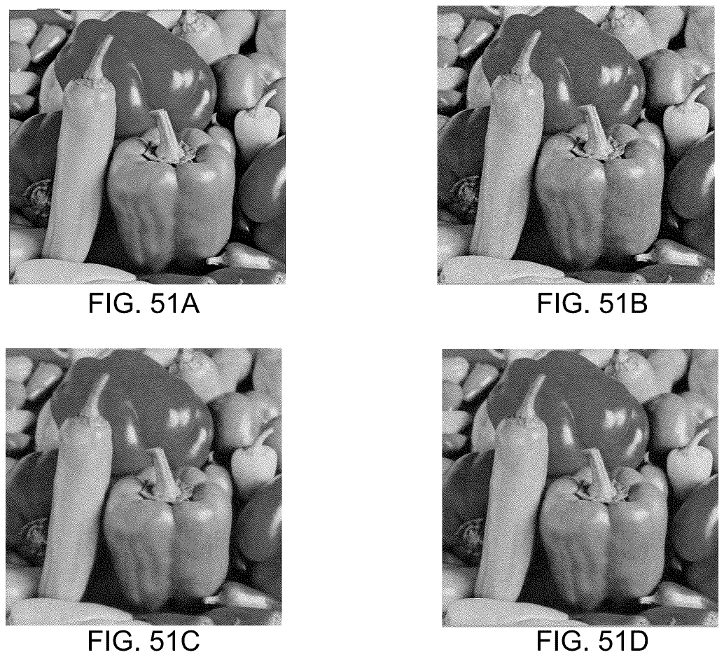

FIGS. 51A-D are a series of images illustrating the result of a noise reduction process such as the processes 5000, 5010, 5020, described above, applied to reduce the noise of an image. FIG. 51A represents an ideal noiseless image, and FIG. 51B represents the same image with 16LSBrms of Gaussian noise. In this example, two independent noisy test images were created by adding in two uncorrelated noise sources with 16LSBrms of noise to each ideal image. The p-p noise is 154LSB out of a 255LSB full scale. Provided that the clean image is a nominal 90LSB rms, the unprocessed SNR is 24 dB.

FIG. 51C represents an image resulting from the noise-reduction process as applied to the noisy image of FIG. 51B and a corresponding second noisy image. Each noisy image was converted to the frequency domain first row by row and separately, column by column. This is not the case of the standard 2D Fourier transform, where the frequency result of the row-by-row Fourier transform is transformed further, but column by column. Each image shown here has two Fourier transforms applied independently row-wise and column-wise.

Each 512-pixel row or pixel column was windowed for the Fourier transform with a rectangular window. There is no Short Time Frequency Transform (STFT) process with Overlap-Add (OLA) as is the case for a continuous audio or RF signal stream. The image Headlight processing is therefore simpler than the audio Headlight process. A further particularity of the image process is that the DC term of each row and each column bypasses the noise processing and is reintroduced from the input directly to the output at each of the two row-wise and column-wise processed images. If the DC term is not carried forward to the end, tonal banding artifacts result. In audio processing there is no steady-state DC term.

After processing row-wise and column-wise, the two image (time) domain results are added to create the final image shown below. Each of the two process paths yield a 12 dB reduction in uncorrelated noise. The final image is the sum of these two 12 dB noise reduced images and will result in a noise reduction of −15 db from SNR=24 dB before noise reduction to SNR=39 dB after noise reduction.

The Headlight processed image can be further improved by summing ¾ of the Headlight processed image with ¼ of the average of the two input noisy images. This improves the SNR only about 0.2 dB in a solid gray test area, but significantly reduces canvas texture artifacts in smooth areas while sharpening features that are 1 or 2 pixels wide. FIG. 51D shows this improvement.

While example embodiments have been particularly shown and described, it will be understood by those skilled in the art that various changes in form and details may be made therein without departing from the scope of the embodiments encompassed by the appended claims.

What is claimed is:

1. A method comprising:
generating, from first and second signals, virtual flux patterns representing a surface integral of a virtual vector field, the first and second signals being synchronous and comprising a common data element and distinct noise elements;
generating a plurality of virtual flux magnitude patterns based on the plurality of virtual flux patterns, each of the plurality of virtual flux magnitude patterns representing an absolute value of a respective one of the plurality of virtual flux patterns; and
generating a virtual flux beam as a function of the plurality of virtual flux magnitude patterns, the virtual flux beam being a noise-reduced signal corresponding to the common data element of the first and second signals.

2. The method of claim 1, wherein the first and second signals correspond to one of a radio signal, an audio signal, and an image.

3. The method of claim 1, further comprising delaying one of the first and second signals relative to the other prior to generating the plurality of virtual flux magnitude patterns.

4. The method of claim 1, wherein generating the plurality of virtual flux magnitude patterns is based on a delayed version of one of the first and second signals.

5. The method of claim 1, wherein the virtual flux beam is a result of a mathematical operation comprising exclusively at least one of an addition and a subtraction of the plurality of virtual flux magnitude patterns.

6. The method of claim 1, wherein generating the plurality of virtual flux magnitude patterns includes processing each of the plurality of virtual flux signals via a Fourier transform.

7. The method of claim 6, wherein generating the virtual flux beam includes processing a signal representing the plurality of flux magnitude patterns via an inverse Fourier transform.

8. A circuit for signal noise reduction, comprising:
a Fourier transform (FT) stage configured to perform FT on a first signal and a second signal, the first and second signals comprising a common data element and distinct noise elements, the FT stage outputting first and second TF signals;
a delay block configured to output a delayed signal corresponding to the first TF signal;
a first summation stage configured to sum the delayed signal and the second TF signal via a first linear matrix;
a first difference stage configured to output a difference between the delayed signal and the second TF signal via a second linear matrix;
a frequency filter configured to generate first and second equalized signals corresponding to outputs of the first summation stage and the first difference stage, respectively;
a scaling stage configured to generate distinct first and second scaled signals corresponding to the first equalized signal;
a second summation stage configured to generate sums of 1) the first equalized and scaled signal and the second equalized signal, and 2) the second equalized and scaled signal and the second equalized signal;
a signal magnitude stage configured to determine a first magnitude of the output of the first summation stage and to determine a second magnitude of the output of the second summation stage;
a second difference stage configured to output a difference between the sums generated by the second summation stage;
a frequency filter configured to generate an equalized signal corresponding to the first magnitude of the output of the first summation stage; and
a third summation stage configured to output a reduced noise signal based on a summation of the output of the second difference stage and the equalized signal corresponding to the first magnitude of the output of the first summation stage.

9. The circuit of claim 8, wherein the FT stage is a short-time Fourier transform (STFT) stage configured to perform STFT on the first signal and a second signal, and wherein the first and second FT signals are SFTF signals.

10. The circuit of claim 9, wherein the STFT stage is configured to perform the STFT via a rectangular window.

11. The circuit of claim 8, wherein the FT stage implements a straight sequential Fourier transform that is absent an overlap-add function.

12. The circuit of claim 8, wherein the delay block outputs the delayed signal with a 90-degree delay.

13. A circuit for signal noise reduction, comprising:
a summation and difference stage configured to generate, from first and second signals, virtual flux patterns representing a surface integral of a virtual vector field, the first and second signals being synchronous and comprising a common data element and distinct noise elements;
a magnitude stage configured to generate a plurality of virtual flux magnitude patterns based on the plurality of virtual flux patterns, each of the plurality of virtual flux magnitude patterns representing an absolute value of a respective one of the plurality of virtual flux patterns; and
a combiner stage configured to generate a virtual flux beam as a function of the plurality of virtual flux magnitude patterns, the virtual flux beam being a noise-reduced signal corresponding to the common data element of the first and second signals.

14. The circuit of claim 13, wherein the first and second signals correspond to one of a radio signal, an audio signal, and an image.

15. The circuit of claim 13, further comprising a delay stage configured to delay one of the first and second signals relative to the other prior to generating the plurality of virtual flux magnitude patterns.

16. The circuit of claim 13, wherein the magnitude stage generates the plurality of virtual flux magnitude patterns based on a delayed version of one of the first and second signals.

17. The circuit of claim 13, wherein the circuit generates the virtual flux beam as a result of a mathematical operation comprising exclusively at least one of an addition and a subtraction of the plurality of virtual flux magnitude patterns.

18. The circuit of claim 13, wherein the circuit generates a refined virtual flux beam that is a sum of (i) a first fraction of the virtual flux beam and (ii) a second fraction of an average of the first signal and the second signal.

19. The circuit of claim 18, wherein the first fraction is ¾, and the second fraction is ¼.
